(19) United States
(12) Patent Application Publication
(10) Pub. No.: US 2016/0149626 A1
(43) Pub. Date: May 26, 2016

(54) Mapping Codewords

(71) Applicant: TELEFONAKTIEBOLAGET L M ERICSSON (PUBL), Stockholm (SE)

(72) Inventors: Mattias Frenne, Uppsala (SE); Svante Bergman, Hägersten (SE); David Hammarwall, Vallentuna (SE); George Jöngren, Sundbyberg (SE)

(21) Appl. No.: 14/899,955

(22) PCT Filed: Jun. 19, 2014
(86) PCT No.: PCT/SE2014/050761

§ 371 Date: Dec. 18, 2015

Related U.S. Application Data
(60) Provisional application No. 61/837,351, filed on Jun. 20, 2013.

(51) Int. Cl. H04B 7/04; H04B 7/02

(52) U.S. Cl. CPC H04B 7/0469; H04B 7/022; H04B 7/0478; H04B 7/0486; H04W 88/08

(57) ABSTRACT

It is presented a method for mapping one or more codewords to antennas of the same cell under control of a radio base station of a cellular communication system, wherein the antennas are distributed over at least two different sites. The method is performed in a radio base station and comprises: determining a distribution matrix such that each one of the one or more codewords is substantially only mapped to at least two antennas located at only one site; and applying the distribution matrix to the one or more codewords. Corresponding radio base stations, computer program and computer program product are also presented.

### TECHNICAL FIELD

Embodiments presented herein relate to a method, radio base stations, a computer program and a computer program product for mapping codewords to antennas.

### BACKGROUND

Radio base stations provide connectivity to one or more wireless terminals using one or more antennas. Sometimes a single radio base station may have multiple antennas that are provided at different sites. In such a situation, the path loss to each antenna can vary significantly for a wireless device in the cell, which can lead to significant antenna gain imbalances. It would be of great benefit if there were to be some way in which resource usage is adapted to mitigate such antenna gain imbalances.

### SUMMARY

According to a first aspect, it is presented a method for mapping one or more codewords to antennas of the same cell under control of a radio base station of a cellular communication system, wherein the antennas are distributed over at least two different sites. The method is performed in a radio base station and comprises: determining a distribution matrix such that each one of the one or more codewords is substantially only mapped to at least two antennas located at only one site; and applying the distribution matrix to the one or more codewords. By mapping each codeword to substantially one site only, the antenna gain imbalance is effectively mitigated or even eliminated.

In the determining, the distribution matrix may be determined such that each one of the one or more codewords is only mapped to at least two antennas located at only one site.

The method may further comprise: selecting one of a set of predefined precoding matrices; and multiplying the selected precoding matrix with the distribution matrix, which results in a composite precoding matrix. In such a case, the applying the distribution matrix comprises applying the composite precoding matrix.

The determining a distribution matrix may comprise determining a distribution matrix which distributes each one of a plurality of Channel State Information Reference Signals (CSI-RS) to all of the at least two different sites, when the Channel State Information Reference Signals are passed through the distribution matrix but not the selected one of the set of precoding matrices. In other words, CSI-RS (or CRS) are distributed to all sites, while codewords are distributed to substantially only one site. This allows the improvements in antenna gain imbalance to be provided, while still allowing reference signals for radio channel evaluation to be transmitted form all antennas.

The determining a distribution matrix may comprise: selecting N orthogonal vectors from a codebook \tilde{w}^{(c)} of precoding matrices, where N is the number of antennas, the orthogonal vectors being denoted wₐ_{₁}, wₐ_{₂}, . . . , wₐ_{_{N}}; forming a matrix T′=[wₐ_{₁} wₐ_{₂} . . . wₐ_{_{N}}]^{H} where [ ]^{H} denotes a Hermitian transpose; and forming the distribution matrix as:

$$T = [ \begin{matrix}{T}^{′} & 0 \\ 0 & {T}^{′}\end{matrix} ] .$$

The sites may be geographically separated such that there is a significant difference in average path loss.

The sites may be geographically separated such that there is a difference in average path loss of at least 10 dB.

The sites may be geographically separated by more than 10 metres.

Each site may comprise two cross-polarised antennas.

At least part of the one or more codewords may be associated with Demodulation Reference Signals.

The determining a composite precoding matrix may comprise determining a composite precoding matrix such that each one of the one or more codewords is mapped to all antennas of only one site.

The determining a composite precoding matrix may comprise determining a composite distribution matrix such that each one of the two codewords is mapped to different respective sites.

The antennas may be used for Multiple Input Multiple Output.

According to a second aspect, it is presented a radio base station for mapping one or more codewords to antennas of the same cell under control of the radio base station of a cellular communication system. The antennas are distributed over at least two different sites. The radio base station comprises: a processor; and a memory storing instructions that, when executed by the processor, causes the radio base station to: determine a distribution matrix such that each one of the one or more codewords is substantially only mapped to one or more antennas located at only one site; and apply the distribution matrix to the one or more codewords.

The instructions to determine may comprise instructions that, when executed by the processor, causes the radio base station to determine the distribution matrix such that each one of the one or more codewords is only mapped to at least two antennas located at only one site.

The memory may further comprise instructions that, when executed by the processor, causes the radio base station to: select one of a set of predefined precoding matrices; and multiply the selected precoding matrix with the distribution matrix, which results in a composite precoding matrix. In such a case, the instructions to apply the distribution matrix comprise instructions to apply the composite precoding matrix.

The instructions to determine may comprise instructions that, when executed by the processor, causes the radio base station to determine a distribution matrix which distributes each one of a plurality of Channel State Information Reference Signals to all of the at least two different sites, when the Channel State Information Reference Signals are passed through the distribution matrix but not the selected one of the set of precoding matrices.

The instructions to determine a distribution matrix may comprise instructions that, when executed by the processor, causes the radio base station to: select N orthogonal vectors from a codebook \tilde{w}^{(c)} of precoding matrices, where N is the number of antennas, the orthogonal vectors being denoted; wₐ_{₁} wₐ_{₂}, . . . , wₐ_{_{N}} form a matrix T′=[wₐ_{₁} wₐ_{₂} . . . wₐ_{_{N}}]^{H} where denotes a Hermitian transpose; and form the distribution matrix as:

$$T = [ \begin{matrix}{T}^{′} & 0 \\ 0 & {T}^{′}\end{matrix} ] .$$

The sites may be geographically separated such that there is a significant difference in average path loss.

The sites may be geographically separated such that there is a difference in average path loss of at least 10 dB.

The sites may be geographically separated by more than 10 metres.

Each site may comprise two cross-polarised antennas.

At least part of the one or more codewords may be associated with Demodulation Reference Signals.

The instructions to determine a composite precoding matrix may comprise determining a composite precoding matrix such that each one of the one or more codewords is mapped to all antennas of only one site.

The instructions to determine a composite precoding matrix may comprise instructions to determine a composite distribution matrix such that each one of the two codewords is mapped to different respective sites.

The antennas, in operation, may be used for Multiple Input Multiple Output.

According to a third aspect, it is presented a radio base station comprising: means for determining a distribution matrix such that each one of the one or more codewords is substantially only mapped to at least two antennas located at only one site, the antennas being part of a set of antennas distributed over at least two different sites of the same cell under control of a radio base station of a cellular communication system; and means for applying the distribution matrix to the one or more codewords.

According to a fourth aspect, it is presented a computer program for mapping one or more codewords to antennas of the same cell under control of a radio base station of a cellular communication system, wherein the antennas are distributed over at least two different sites. The computer program comprises computer program code which, when run on a radio base station causes the radio base station to: determine a distribution matrix such that each one of the one or more codewords is substantially only mapped to at least two antennas located at only one site; and apply the distribution matrix to the one or more codewords.

According to a fifth aspect, it is presented a computer program product comprising a computer program according to the fourth aspect and a computer readable means on which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Embodiments are now described, by way of example, with reference to the accompanying drawings, in which:

FIG. 1 is a schematic diagram illustrating geographically separated cross-pole antennas where every second cross-pole antenna transmits antenna port 1 and 3 and the other antennas transmit antenna port 2 and 4;

FIG. 2 is a schematic diagram illustrating a corridor where the cross-pole group of antenna ports are interleaved across the antenna sites;

FIG. 3 is a schematic diagram illustrating LTE (Long Term Evolution) downlink physical resource;

FIG. 4 is a schematic diagram illustrating LTE time-domain structure;

FIG. 5 is a schematic diagram illustrating mapping of LTE physical control signaling, data link and cell specific reference signals within a downlink subframe;

FIG. 6 is a schematic diagram illustrating transmission structure of precoded spatial multiplexing mode in LTE;

FIG. 7A-E are schematic diagrams illustrating codeword to layer mapping for four antenna system with precoding in different scenarios with different number of layers;

FIG. 8 is a schematic diagram illustrating the introduction of virtual antenna ports by the matrix T for measurements. The four CSI-RS (Channel State Information Reference Signals) signals define the virtual antenna ports. A wireless device that is closer to site 1 than site 2 of the same cell will experience a significant difference in the received power among the antenna ports of the base station;

FIG. 9 is a schematic diagram illustrating the introduction of virtual antenna ports by the matrix T for PDSCH (Physical Downlink Shared Channel) transmission and possibly also DMRS (Demodulation Reference Signals) transmission, if applicable. A wireless device that is closer to site 1 than site 2 of the same cell will experience a significant difference in the received power among the antenna ports of the base station;

FIG. 10 is a schematic diagram illustrating an environment where embodiments presented herein can be applied;

FIG. 11 is a schematic diagram showing some components of the radio base station of FIGS. 8-10;

FIG. 12 is a schematic diagram showing some components of the wireless device of FIGS. 8-10;

FIGS. 13 A-C are flow chart illustrating embodiments of mapping of codeword to antennas;

FIG. 14 is a schematic diagram showing functional modules of the radio base station 1 of FIGS. 8-10; and

FIG. 15 shows one example of a computer program product 90 comprising computer readable means.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

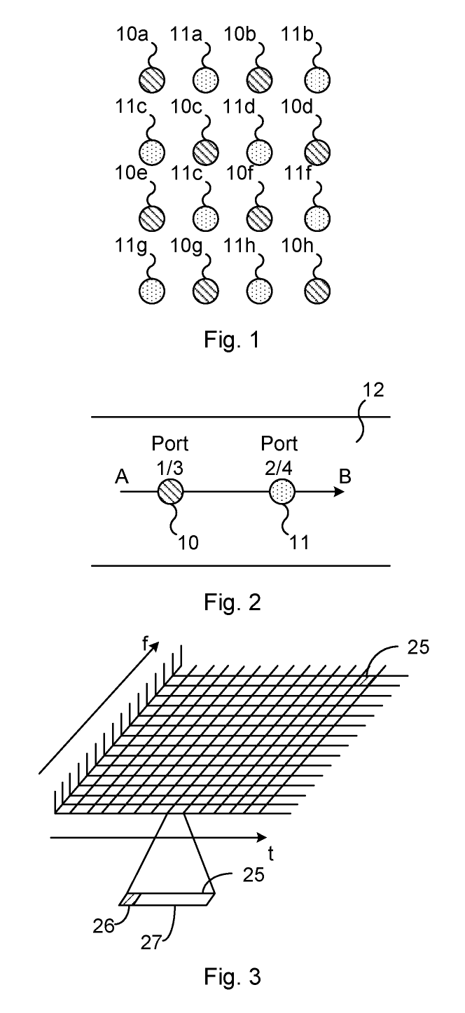

An antenna setup that is common in, e.g., indoor deployments is the so called interleaved deployment where antennas belonging to the same radio base station are placed widely apart. See FIG. 1 for an example where cross-pole antennas are assumed (each dot is an antenna site that corresponds to two antenna ports).

Terminals that are connected to a serving cell that is defined over widely separated pairs of antennas may suffer from problems due to antenna path/gain imbalance.

For instance, a user that is located near the one of the sites will typically experience an order of magnitude stronger received signal from that particular site compared to the other site (assuming that the transmit power for all antennas is equal).

FIG. 1 is a schematic diagram illustrating geographically separated cross-pole antennas where every other cross-pole antenna transmits antenna ports 1 and 3 and the other antennas transmit antenna ports 2 and 4. All four antenna ports 1-4 are of the same cell under control of a single radio base station of a cellular communication system. It is to be noted that the four antenna ports could also be numbered from 0 to 3. In other words, a first set of sites 10a-h have antennas for transmitting from antenna ports 1 and 3 and a second set of sites 11a-h have antennas for transmitting from antenna ports 2 and 4. The sites are here interleaved such that the closest neighbors for each site are sites from the other set. Hence, in the example for FIG. 1, when a wireless device is near any one of a first set of sites 10a-h and further away from each site in the second set of sites 11a-h, the channel from port 1/3 will be much stronger than the channel from port 2/4 in this 4 antenna port case.

An advantage of an interleaved antenna port deployment is a reduction in the need of cabling (primarily when upgrading existing passive based distributed antenna systems to support MIMO (Multiple Input Multiple Output) and halving the number of antennas compared to deploying two co-located antennas per site (i.e., a geographic position for one or more antennas).

Upgrading existing antennas deployments originally using SIMO (Single Input Multiple Output) to use MIMO may also be considerably simpler with less efforts that need to be spent on laying out new cabling or adding antennas. For the same total number of antennas, it is reasonable to expect that the interleaved approach performs better than the co-located one, since the inter-site distance needs to increase when all antennas are used per site. These points make it valuable for LTE to support such an interleaved antenna port scheme to provide ample opportunities for an efficient deployment.

Another indoor environment consists of one floor of an office building. Sites for antennas are placed in the corridors connecting various rooms for office space and every other antenna “site” is transmitting port 1 and 3 and every other port 2 and 4 (for the cross-polarized antenna setup case). An example also showing this 4TX (four transmitter antennas) case is shown in FIG. 2.

FIG. 2 is a schematic diagram illustrating a corridor 12 where the cross-pole group of antenna ports is interleaved across the antenna sites. A first site 10 transmits signals from antenna ports 1 and 3 and a second site 11 transmits signals from ports 2 and 4. There can be more sites with antenna ports on either side of the sites 10-11 shown here, interleaved with each other.

Close to a site, the antenna ports undergo a very large difference in receive power, up to 35 dB, creating a highly rank-deficient channel. Rank-one reporting and transmission should therefore be more likely, although that would also depend on the received signal level, which is now substantially stronger because of the short distance to the site. In any case, the performance close to a site is expected to be very good because of the strong signal.

It is problematic for the wireless device to handle a situation when one or two of the four antenna ports are much stronger than the other antenna ports. The performance drops to such a low level that an interleaved distributed antenna deployment strategy is severely hampered if many wireless devices exhibit a similar behavior.

A number of problems are associated with antenna gain imbalance, for instance:
The estimation of the channel for both demodulation and for deriving channel state information from weaker antenna ports becomes very difficult and may result in corrupted CSI reporting, which will impair link adaptation and scheduling, as well as performance degradation in demodulation of PDSCH and EPDCCH (Enhanced Physical Downlink Control Channel).
When transmitting a DL (Downlink) MIMO codeword (i.e., a data transport block), the part of the transmission to a wireless device from its associated weaker antenna port may cause interference to wireless devices in other cells while the associated part of the received codeword signal is very weak at the wireless device.
Since a DL MIMO codeword is transmitted from all four antennas (based on the existing codebook), the link adaptation needs to consider both “weak” ports and “strong” ports and link adaptation is suboptimal leading to a loss in spectral efficiency.

Note that although terminology from 3GPP (Third Generation Partnership Project) LTE has been used in embodiments herein, this should not be seen as limiting the scope of protection to only the aforementioned system. Other wireless systems, including WCDMA, WiMax, UMB, and GSM, may also benefit from exploiting the ideas covered within this disclosure.

LTE uses OFDM (Orthogonal Frequency Division Multiplex) in the downlink and DFT (Discrete Fourier Transform)-spread OFDM in the uplink. The basic LTE physical resource can thus be seen as a time-frequency grid as illustrated in FIG. 3, where each resource element 25 corresponds to one subcarrier during one OFDM symbol interval (on a particular antenna port). Each resource element 25 comprises cyclic prefix section 26 and a main section 27. An antenna port is defined such that the channel over which a symbol on the antenna port is conveyed can be inferred from the channel over which another symbol on the same antenna port is conveyed. There is one resource grid per antenna port.

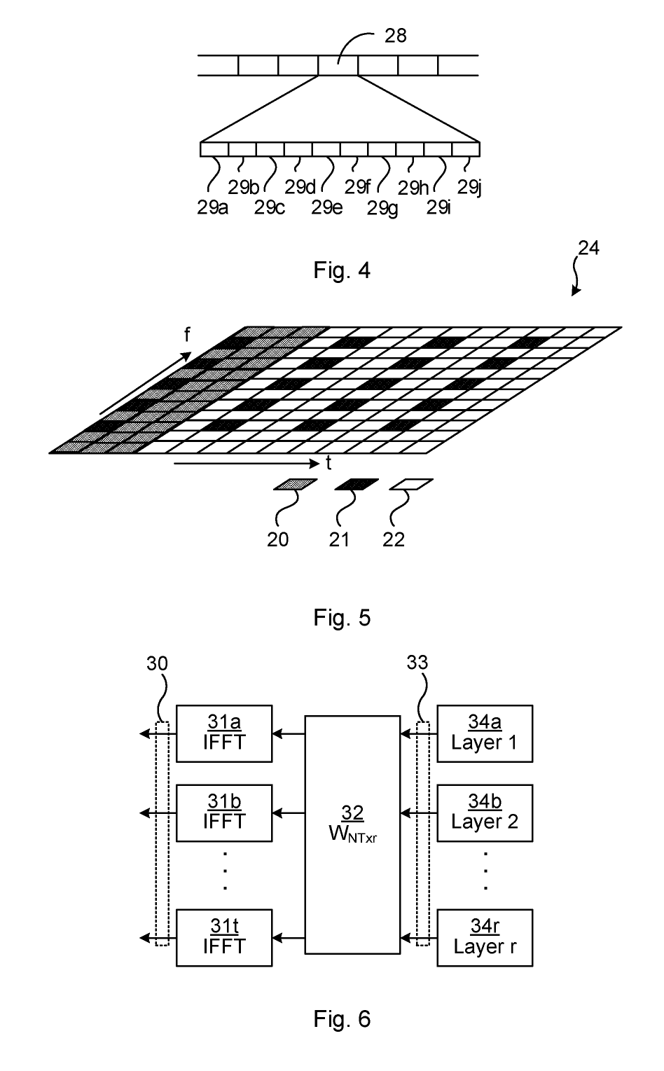

FIG. 3 is a schematic diagram illustrating the LTE downlink physical resource. In the time domain, LTE downlink transmissions are organized into radio frames of 10 ms, each radio frame consisting of ten equally-sized subframes of 1 ms as illustrated in FIG. 4. A subframe is divided into two slots, each of 0.5 ms time duration.

FIG. 4 is a schematic diagram illustrating LTE time-domain structure. In the time domain, LTE downlink transmissions are organised into radio frames 28 of 10 ms, each radio frame consisting of ten equally-sized subframes 29a-j of length T_{subframe}=1 ms. The resource allocation in LTE is described in terms of resource blocks, where a resource block corresponds to one slot in the time domain and twelve contiguous 15 kHz subcarriers in the frequency domain. Two in time consecutive resource blocks represent a resource block pair and corresponds to the time interval upon which scheduling operates.

Transmissions in LTE are dynamically scheduled in each subframe where the base station transmits downlink assignments/uplink grants to certain wireless devices via the physical downlink control information (PDCCH (Physical Downlink Control Channel) and ePDCCH (Enhanced PDCCH)). The PDCCHs are transmitted in the first OFDM symbol(s) in each subframe and spans (more or less) the whole system bandwidth. A wireless device that has decoded a downlink assignment, carried by a PDCCH, knows which resource elements in the subframe that contain data aimed for the wireless device. Similarly, upon receiving an uplink grant, the wireless device knows which time/frequency resources it should transmit upon. In LTE downlink, data is carried by the physical downlink shared data link (PDSCH) and in the uplink the corresponding link is referred to as the physical uplink shared link (PUSCH).

The use of and enhanced downlink control signaling (ePDCCH) is available for terminals of Release 11 or later. Such control signaling have similar functionalities as PDCCH, with the fundamental difference of requiring wireless device specific DMRS instead of CRS (Cell specific Reference Signals) for its demodulation. One advantage is that wireless device specific spatial processing may be exploited for ePDCCH.

Demodulation of sent data requires estimation of the radio channel which is done by using transmitted reference signals (RS), i.e., signals known by the receiver. In LTE, CRS signals are transmitted in all downlink subframes and in addition to assist downlink channel estimation they are also used for mobility measurements performed by the wireless devices. LTE also supports wireless device specific RS aimed only for assisting channel estimation for demodulation purposes. FIG. 5 illustrates how the mapping of physical control/data channels and signals can be done on resource elements within a downlink subframe. In this example, the PDCCHs occupy the first out of three possible OFDM symbols, so in this particular case the mapping of data could start already at the second OFDM symbol. Since the CRS is common to all wireless devices in the cell, the transmission of CRS cannot be easily adapted to suit the needs of a particular wireless device. This is in contrast to wireless device specific RS which means that each wireless device has RS of its own placed in the data region of FIG. 3 as part of PDSCH.

FIG. 5 is a schematic diagram illustrating mapping of LTE physical control signaling, data link and cell specific reference signals within a downlink subframe.

Downlink transmissions are dynamically scheduled, i.e. in each subframe the network node transmits control information about to which wireless devices data is transmitted and upon which resource blocks the data is transmitted, in the current downlink subframe. This control signaling is typically transmitted in a control region 20 in the first one, two or three OFDM symbols in each subframe. The length of the control region 20, which can vary on subframe basis, is conveyed in the Physical Control Format Indicator (PCFICH). The PCFICH is transmitted within control region 20, at locations known by wireless devices. After a wireless device has decoded the PCFICH, it thus knows the size of the control region and in which OFDM symbol the data transmission starts. The downlink subframe also contains the CRS signals 21, which are known to the receiver and used for interference estimation and coherent demodulation of, e.g., the control information and payload data. The remaining resource elements are available for payload data 22, also comprising interspersed CRS elements 21. A downlink system with CFI=3 OFDM symbols as control for a resource block 24 is illustrated in FIG. 5.

Also transmitted in the control region 20 is the Physical Hybrid-ARQ (Automatic Repeat Request) Indicator, which carries ACK/NACK responses to a terminal to inform if the uplink data transmission in a previous subframe was successfully decoded by the base station or not.

As previously indicated, CRS are not the only reference signals available in LTE. As of LTE Release-10, a new RS concept was introduced with separate wireless device specific RS for demodulation of PDSCH and RS for measuring the channel for the purpose of channel state information (CSI) feedback from the wireless device. The latter is referred to as CSI-RS. CSI-RS are not transmitted in every subframe and they are generally sparser in time and frequency than RS used for demodulation. CSI-RS transmissions may occur every 5^{th}, 10^{th}, 20^{th}, 40^{th}, or 80^{th} subframe according to an RRC (Radio Resource Control) configured periodicity parameter and an RRC configured subframe offset.

A wireless device operating in connected mode can be requested by the base station to perform channel state information (CSI) reporting, e.g. reporting a suitable rank indicator (RI), one or more precoding matrix indices (PMIs) and a channel quality indicator (CQI). Rank is the number of transmission layers for spatial multiplexing. Other types of CSI are also conceivable including explicit channel feedback and interference covariance feedback. The CSI feedback assists the base station in scheduling, including deciding the subframe and RBs for the transmission, which transmission scheme/precoder to use, as well as provides information on a proper user bit rate for the transmission (link adaptation).

In LTE, both periodic and aperiodic CSI reporting is supported. In the case of periodic CSI reporting, the terminal reports the CSI measurements on a configured periodical time basis on the physical uplink control signaling (PUCCH), whereas with aperiodic reporting the CSI feedback is transmitted on the physical uplink shared channel (PUSCH) at pre-specified time instants after receiving the CSI grant from the base station. With aperiodic CSI reports, the base station can thus request CSI reflecting downlink radio conditions in a particular subframe. A multitude of feedback modes are available. The radio base station can configure the wireless device to report according to one feedback mode on PUSCH and another on PUCCH. The aperiodic modes on PUSCH are referred to as PUSCH 1-2, 2-0, 2-2, 3-0, 3-1 and 3-2, respectively, and the periodic ones on PUCCH as 1-0, 1-1, 2-0 and 2-1, respectively.

### Multi-Antenna Techniques

Multi-antenna techniques can significantly increase the data rates and reliability of a wireless communication system. The performance is in particular improved if both the transmitter and the receiver are equipped with multiple antennas, which results in a multiple-input multiple-output (MIMO) communication channel. Such systems and/or related techniques are commonly referred to as MIMO.

The LTE standard is currently evolving with enhanced MIMO support. A core component in LTE is the support of MIMO antenna deployments and MIMO related techniques. A current working assumption in LTE-Advanced is the enhanced support of up to 4-layer spatial multiplexing for 4 Tx (transmission) antennas with an enhanced channel dependent precoding. The new precoding is aimed for high data rates in favorable channel conditions and is especially targeting cross-polarized antenna setups. An illustration of the spatial multiplexing operation is provided in FIG. 1 and is described above.

FIG. 6 is a schematic diagram illustrating transmission structure of precoded spatial multiplexing mode in LTE. The information carrying symbol vector 33 denoted s from r layers 34a-r is multiplied by an N_{T}×r precoder matrix W_{N}_{_{T}}_{×r}, in a precoder 32, which serves to distribute the transmit energy in a subspace of the N_{T} (corresponding to N_{T} antenna ports 30)-dimensional vector space to t (t=N_{T}) IFFT modules 31a-t. The precoder matrix is typically selected from a codebook of possible precoder matrices, and typically indicated by means of a precoder matrix indicator (PMI), which specifies a unique precoder matrix in the codebook for a given number of symbol streams. If the precoder matrix is confined to have orthonormal columns, then the design of the codebook of precoder matrices corresponds to a Grassmanian subspace packing problem. The r symbols in s each correspond to a layer and r is referred to as the transmission rank. In this way, spatial multiplexing is achieved since multiple symbols can be transmitted simultaneously over the same time/frequency resource element (TFRE). The number of symbols r is typically adapted to suit the current channel properties.

LTE uses OFDM in the downlink (and DFT precoded OFDM in the uplink) and hence the received N_{R}×1 vector yₙ for a certain TFRE on subcarrier n (or alternatively data TFRE number n) is thus modeled by

yₙ=HₙW_{N}_{_{T}}_{×r}sₙ+eₙ, (1)

where eₙ is a noise/interference vector obtained as realizations of a random process. The precoder, W_{N}_{_{T}}_{×r}, can be a wideband precoder, which is constant over frequency, or frequency selective.

The precoder matrix is often chosen to match the characteristics of the N_{R}×N_{T} MIMO channel matrix H, resulting in so-called channel dependent precoding. This is also commonly referred to as closed-loop precoding and essentially strives for focusing the transmit energy into a subspace which is strong in the sense of conveying much of the transmitted energy to the wireless device. In addition, the precoder matrix may also be selected to strive for orthogonalising the channel, meaning that after proper linear equalization at the wireless device, the inter-layer interference is reduced.

In closed-loop precoding for the LTE downlink, the wireless device transmits, based on channel measurements in the forward link (downlink), recommendations to the radio base station of a suitable precoder to use. The radio base station may choose to use the so recommended precoders or it may decide to use other precoders. The reporting from the wireless device is constrained to a codebook, but the transmission from the radio base station may or may not be constrained to a codebook. The former case corresponds to so-called codebook based precoding on the transmit side and is usually associated with CRS based data transmissions. The case when the transmissions are not constrained to a precoder codebook usually relies on DMRS based transmissions and is sometimes referred to as non-codebook based precoding.

A single precoder that is supposed to cover a large bandwidth (wideband precoding) may be fed back. It may also be beneficial to match the frequency variations of the channel and instead fed back a frequency-selective precoding report, e.g., several precoders, one per sub-band. This is an example of the more general case of channel state information (CSI) feedback, which also encompasses feeding back other entities than precoders to assist the radio base station in subsequent transmissions to the wireless device. Such other information may include channel quality indicators (CQIs) as well as transmission rank indicator (RI).

For the LTE uplink, the use of closed-loop precoding means the radio base station is selecting precoder(s) and transmission rank and thereafter signals the selected precoder that the wireless device is supposed to use.

The transmission rank, and thus the number of spatially multiplexed layers, is reflected in the number of columns of the precoder. For efficient performance, it is important that a transmission rank that matches the channel properties is selected. Often, the device selecting precoders is also responsible for selecting the transmission rank—one way is to simply evaluate a performance metric for each possible rank and pick the rank which optimizes the performance metric. These kinds of calculations are often computationally burdensome and it is therefore an advantage if calculations can be re-used across different transmission ranks. Re-use of calculations is facilitated by designing the precoder codebook to fulfill the so-called rank nested property. This means that the codebook is such that there always exists a column subset of a higher rank precoder that is also a valid lower rank precoder.

The 4 Tx Householder codebook in LTE downlink is an example of a codebook where the rank nested property is fulfilled. This property is not only useful for reducing computational complexity, but is also important in simplifying overriding a rank selection at another device than the device that has chosen the transmission rank. Consider, for example, the LTE downlink, where the wireless device is selecting precoder and rank and, conditioned on such a choice, computes CQI representing the quality of the effective channel formed by the selected precoder and the channel. Since the CQI is being reported conditioned on a certain transmission rank, performing rank override at the radio base station side makes it difficult to know how to adjust the CQI to take the new rank into account, However, if the precoder codebook fulfills the rank nested property, overriding the rank to a lower rank precoder is possible by selecting a column subset of the original precoder. Since the new precoder is a column subset of the original precoder, the CQI tied to the original precoder gives a lower bound on the CQI if the new reduced rank precoder is used. Such bounds can be exploited for reducing the CQI errors associated with rank override, thereby improving the performance of the link adaptation.

### A Factorized Precoder Design

Maintaining low signaling overhead is a critical design target in wireless systems. Signaling of precoders can easily consume a large portion of the resources unless carefully designed. The structure of possible precoders and the overall design of the precoder codebook play an important role in keeping the signaling overhead low. A particularly promising precoder structure involves decomposing the precoder into two matrices, a so-called factorized precoder. The precoder can then be written as a product of two factors

W_{N}_{_{T}}_{×r}=W_{N}_{_{T}}_{×k}^{(c)}W_{k×r}^{(t)}, (2)

where an N_{T}×k conversion precoder W_{N}_{_{T}}_{×k}^{(c)} strives to capture wideband/long-term properties of the channel such as correlation while a k×r tuning precoder W_{k×r}^{(t)}, targets frequency-selective/short-term properties of the channel. Together they form the overall precoder W_{N}_{_{T}}_{×r} which is induced by the signaled entities. The conversion precoder is typically, but not necessarily, reported with a coarser granularity in time and/or frequency than the tuning precoder to save overhead and/or complexity. The conversion precoder serves to exploit the correlation properties for focusing the tuning precoder in “directions” where the channel on average is “strong”. Typically, this is accomplished by reducing the number of dimensions k over which the tuning precoder should cover, i.e., the conversion precoder W_{N}_{_{T}}_{×k}^{(c)} becomes a tall matrix with a reduced number of columns and consequently the number of rows k of the tuning precoder W_{k×r}^{(t)} is reduced as well. With such a reduced number of dimensions, the codebook for the tuning precoder, which easily consumes most of the signaling resources since it needs to be updated with fine granularity, can be made smaller while still maintaining good performance.

This type (2) of precoder has been standardized for 8TX base stations and is now under consideration (3GPP Rel.12) also for 4TX base station, due to its good performance when cross-polarized antenna setups is used. Hence, the wireless device can be configured to use either the Rel.8 4TX codebook (based on Householder design theory) or the new Rel.12 4TX codebook based on (2).

The conversion and the tuning precoders each have a codebook of their own. The conversion precoder targets having high spatial resolution and thus a codebook with many elements while the codebook the tuning precoder is selected from needs to be rather small in order to keep the signaling overhead at a reasonable level. The two codebooks can also be viewed as representing one larger codebook consisting of the set of precoders W_{N}_{_{T}}_{×r} obtained as all possible combinations of W_{N}_{_{T}}_{×k}^{(c)} and W_{k×r}^{(t)}. For notational convenience, the conversion precoder is sometimes referred to as W₁ and the tuning precoder W₂ leading to an effective precoder W=W₁W₂. We will typically use this notation throughout this disclosure except in this background section. In LTE, W₁ is the same for the entire system bandwidth, so-called wideband reporting, while W₂ can vary from one sub-band to another (a sub-band is a set of consecutive resource blocks over frequency) and thus supporting frequency-selective reporting. The second matrix W₂ could also be wideband but then reported more often in time than W₁.

To see how correlations properties are exploited and dimension reduction achieved consider the common case of an array with a total of N_{T} elements arranged into N_{T}/2 closely spaced cross-poles. Based on the polarization direction of the antennas, the antennas in the closely spaced cross-pole setup can be divided into two groups, where each group is a closely spaced co-polarized ULA with N_{T}/2 antennas. Closely spaced antennas often lead to high channel correlation and the correlation can in turn be exploited to maintain low signalling overhead. The channels corresponding to each such antenna group ULA are denoted H_{/} and H_{\}, respectively. For convenience in notation, we are now dropping the subscripts indicating the dimensions of the matrices as well as the subscript n. Assuming now that the conversion precoder W^{(c)} has a block diagonal structure,

$${W}^{( c )} = [ \begin{matrix}{\tilde{W}}^{( c )} & 0 \\ 0 & {\tilde{W}}^{( c )}\end{matrix} ] , \qquad ( 3 )$$

the product of the MIMO channel and the overall precoder can then be written as

$$\begin{matrix}H W = [ {H}_{/} {H}_{\backslash} ] {W}^{( c )} {W}^{( t )} \\ = [ {H}_{/} {H}_{\backslash} ] [ \begin{matrix}{\tilde{W}}^{( c )} & 0 \\ 0 & {\tilde{W}}^{( c )}\end{matrix} ] {W}^{( t )} \\ = [ {H}_{/} {\tilde{W}}^{( c )} {H}_{\backslash} {\tilde{W}}^{( c )} ] {W}^{( t )} = {H}_{eff} {W}^{( t )}\end{matrix} . \qquad ( 4 )$$

As seen, the matrix \tilde{W}^{(c)} separately precodes each antenna group ULA forming a smaller and improved effective channel H_{eff}. If \tilde{W}^{(c)} corresponds to a beamforming vector, the effective channel would reduce to having only two virtual antennas, which reduces the needed size of the codebook used for the second tuning precoder matrix W^{(t)} when tracking the instantaneous channel properties. In this case, instantaneous channel properties are to a large extent dependent upon the relative phase relation between the two orthogonal polarizations.

### Theory on Grid of Beams

Some theory concerning grid of beams and DFT based precoding will be useful for later reference when describing the new 4TX precoder for 3GPP Rel.12. DFT-based precoder vectors for N_{T} transmit antennas can be written in the form

$${w}_{n}^{( {N}_{T} , Q )} = {[ {w}_{1 , n}^{( {N}_{T} , Q )} {w}_{2 , n}^{( {N}_{T} , Q )} … {w}_{{N}_{T} , n}^{( {N}_{T} , Q )} ]}^{T} \\ {w}_{m , n}^{( {N}_{T} , Q )} = exp ( j \frac{2 π}{{N}_{T} Q} m n ) , m = 0 , … , {N}_{T} - 1 , n = 0 , … , Q {N}_{T} - 1 , \qquad ( 5 )$$

where w_{m,n}^{(N}^{_{T}}^{,Q)} is the phase of the m:th antenna, n is the precoder vector index (i.e., which beam out of the QN_{T} beams) and Q is the oversampling factor. To get good performance it is important that the array gain function of two consecutive beams overlap in the angular domain, so that the gain does not drop too much when going from one beam to another. Usually, this requires an oversampling factor of at least Q=2. Thus, for N_{T} antennas, at least 2N_{T} beams are needed.

An alternative parameterization of the above DFT based precoder vectors is

$${w}_{l , q}^{( {N}_{T} , Q )} = {[ {w}_{1 , Q l + q}^{( {N}_{T} , Q )} {w}_{2 , Q l + q}^{( {N}_{T} , Q )} … {w}_{{N}_{T} , Q l + q}^{( {N}_{T} , Q )} ]}^{T} \\ {w}_{m , Q l + q}^{( {N}_{T} , Q )} = exp ( j \frac{2 π}{{N}_{T}} m ( l + \frac{q}{Q} ) ) , \qquad ( 6 )$$

for
m=0, . . . N_{T}−1, l=0, . . . N_{T}−1, q=0, 1, . . . , Q−1,
where l and q together determine the precoder vector index via the relation n=Ql+q. This parameterization also highlights that there are Q groups of beams, where the beams within each group are orthogonal to each other. The q:th group can be represented by the generator matrix

G_{q}^{(N}^{_{T}}⁾=└w_{0,q}^{(N}^{_{T}}^{,Q)}w_{1,q}^{(N}^{_{T}}^{,Q)} . . . w_{N}_{_{T}}_{-,q}^{(N}^{_{T}}^{,Q)}┘. (7)

By making sure that only precoder vectors from the same generator matrix are being used together as columns in the same precoder, it is easy to form sets of precoder vectors for use in so-called unitary precoding where the columns within a precoder matrix should form an orthonormal set.

To maximize the performance of DFT based precoding, it is useful to center the grid of beams symmetrically around the broad size of the array. Such rotation of the beams can be done by multiplying from the left the above DFT vectors wₙ^{(N}^{_{T}}^{,Q)} with a diagonal matrix Wᵣₒₜ having elements

$${[ {W}_{rot} ]}_{m m} = exp ( j \frac{π}{Q {N}_{T}} m ) . \qquad ( 8 )$$

The rotation can either be included in the precoder codebook, or can alternatively be carried out as a separate step where all signals are rotated in the same manner and the rotation can thus be absorbed into the channel from the perspective of the receiver (transparent to the receiver). Henceforth when we talk about DFT-based precoding, it is tacitly assumed that rotation may or may not have been carried out, i.e., both alternatives are possible without explicitly having to mention it.

### A Factorized Precoder Design Based on Grid of Beams

The closely spaced cross-pole is a common antenna array setup, both for 4 Tx as well as for 8 Tx. As indicated in a previous section, the antennas can then be divided into two separate groups depending on the polarization direction of the antenna. The correlation is high among the channels within an antenna group while channels from different antenna groups fade in an independent manner, and to some extent with reduced cross-talk due to the use of orthogonal polarizations. Such an antenna setup thus creates quite pronounced channel properties, which are well-matched to a block diagonal design along the lines of (6).

The precoder on the diagonal, \tilde{W}^{(c)}, is targeting a co-polarized antenna group. Since the correlation is high within the antenna group, it makes sense to use a grid of beam codebook implemented from DFT based precoder vectors. The outer precoder, W^{(t)}, adjusts the relative phase shift between polarizations. For rank 1, the precoder could for example be formed as

$$W = [ \begin{matrix}\tilde{w} & 0 \\ 0 & \tilde{w}\end{matrix} ] [ \begin{matrix}1 \\ α\end{matrix} ] , α ∈ \{ 1 , - 1 , j , - j \} , \qquad ( 9 )$$

where the antenna group beam \tilde{w}εG^{(1,2)} and

$${G}^{( k , Q )} = {{⋃}_{q = 0}}^{Q - 1} {G}_{q}^{( k , Q )} , \qquad ( 10 )$$

with G_{q}^{(k,Q)} representing the set of all k-column columns subsets of the DFT based generator matrix G_{q}^{(Q)} having elements

$${[ {G}_{q}^{( Q )} ]}_{mn} = exp ( j \frac{2 π}{{N}_{T} / 2} m ( n + \frac{q}{Q} ) ) , \qquad ( 11 )$$

where (for notational brevity, column and row indices here start from zero)

q=0,1, . . . ,Q−1, m=0,1, . . . ,N_{T}/2−1, n=0,1, . . . ,N_{T}/2−1. (12)

As seen, the tuning precoder W^{(t)}=[1 α]^{T} adjusts the phase between a first and a second group of antennas (in this case the first and second groups correspond to the upper and lower halves, respectively, of the rows of the precoder W). The rank 2 case would follow similarly as

$$W = [ \begin{matrix}\tilde{w} & 0 \\ 0 & \tilde{w}\end{matrix} ] [ \begin{matrix}1 & 1 \\ α & - α\end{matrix} ] , α ∈ \{ 1 , j \} , \tilde{w} ∈ {G}^{( 1 , 2 )} . \qquad ( 13 )$$

### Codewords and Codewords to Layer Mapping

Modern wireless communication systems targeted for packet based communication often include hybrid ARQ (HARQ) functionality on the physical layer to achieve robustness against the impairments of the radio channel. LTE and WCDMA are two examples of systems in which such functionality is available. The basic idea behind HARQ is to combine forward error correction (FEC) with ARQ by encoding the information containing data block and then adding error-detection information such as CRC. After reception of the coded data block, it is decoded and the error-detection mechanism is used to check whether the decoding was successful or not. If the data block was received without error, an ACK is sent to the transmitter indicating successful transmission of the data block and that the receiver is ready for a new data block. On the other hand, if the data block was not decoded correctly, a NACK is sent, meaning that the receiver expects a retransmission of the same data block. Subsequent to the reception of the retransmission, the receiver may choose to either decode it independently or utilize some or all previous receptions of the same data block in the decoding process.

The encoded bits originating from the same block of information bits are referred to as a codeword. This is also the terminology used in LTE to describe the output from a single HARQ process serving a particular transport block and comprises turbo encoding, rate matching, interleaving etc. The codewords are then modulated and distributed over the antennas.

Precoding is a popular technique used in conjunction with multi-antenna transmission. The basic idea is to mix and distribute the modulation symbols over the antenna while possibly taking the current channel conditions into account. This is often realized by multiplying the information carrying symbol vector by a matrix selected to match the channel. The symbol vector would contain modulation symbols from potentially all the codewords and the codewords thus map to a sequence of symbol vectors. These sequences form a set of parallel symbol streams and each such symbol stream is referred to as a layer. Thus, depending on the precoder choice, a layer may directly correspond to a certain antenna or it may via the precoder mapping be distributed onto several antennas.

In a multi-antenna system (often referred to as a MIMO system), it may make sense to transmit data from several HARQ processes at once, also known as multi-codeword transmission. Depending on the channel conditions, this can substantially increase the data rates, since in favorable conditions the channel can roughly support as many codewords as the minimum of the number of transmit and receive antennas.

One of the most important characteristics of the channel conditions in the field of high rate multi-antenna transmission is the so-called channel rank. Roughly speaking, the channel rank can vary from one up to the minimum number of transmit and receive antennas. Taking a 4×2 system as an example, i.e., a system with four transmitter antennas and two receive antennas; the maximum channel rank is two. The channel rank varies in time as the fast fading alters the channel coefficients. Moreover, it determines how many layers, and ultimately also codewords, can be successfully transmitted simultaneously. Hence, if the channel rank is one at the instant of transmission of two codewords mapping to two separate layers, there is a strong likelihood that the two signals corresponding to the codewords will interfere so much that both of the codewords are erroneously detected at the receiver.

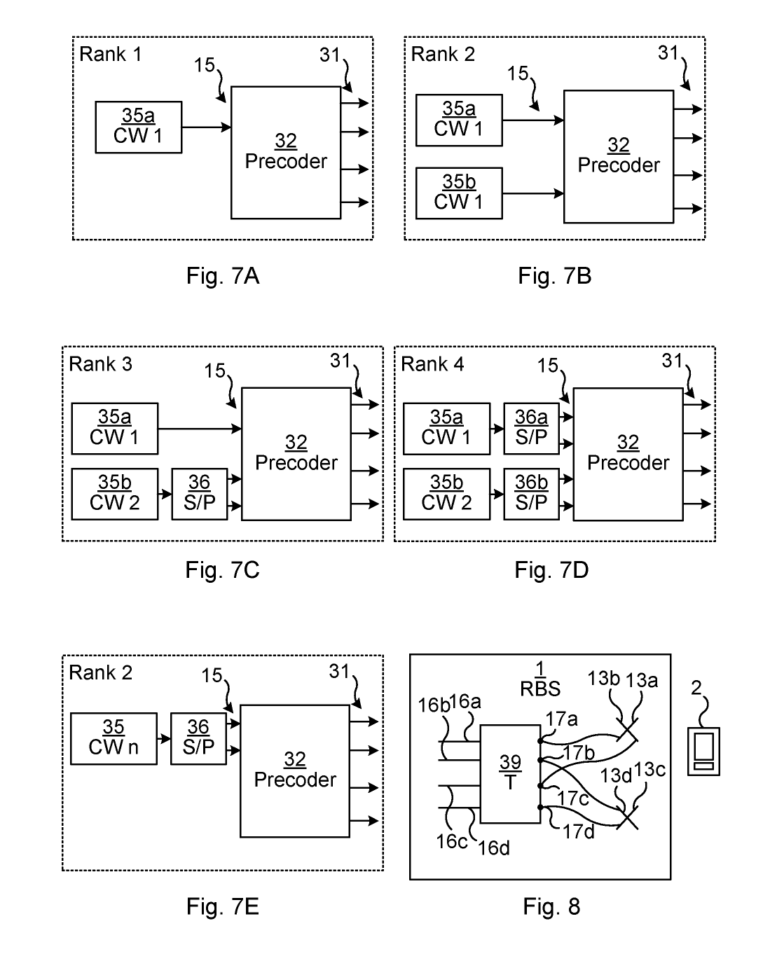

In conjunction with precoding, adapting the transmission to the channel rank involves using as many layers as the channel rank. In the simplest of cases, each layer would correspond to a particular antenna. The issue then arises of how to map the codewords to the layers. Taking the 4 transmit antenna case in LTE as an example, the maximum number of codewords is limited to two while up to four layers can be transmitted. A fixed rank dependent mapping according to FIGS. 7A-E is used.

FIG. 7A-E are schematic diagrams illustrating codeword to layer mapping for four antenna system with precoding in different scenarios with different number of layers 15. Looking first to FIG. 7A, this also means that the first column of the precoding matrix determines the precoder 32 for first codeword 35a in a rank 1 transmission, for distribution to the antenna ports 31.

Looking now to FIG. 7B, for a rank 2 transmission, the second column of the precoding matrix determines the precoder 32 for a second codeword 35b.

Looking now to FIG. 7C, since there are at most two codewords transmitted, it means that for rank 3 transmission, the first codeword 35a uses the first column of the precoding matrix in the precoder 32 while the second codeword 35b uses column two and three after being passed through a splitter 36.

Looking now to FIG. 7D, for a rank 4 transmission, the first codeword 35a uses columns one and two after being passed through a first splitter 36a, whereas the second codeword 35b uses column three and four of the precoding matrix after being passed through a second splitter 36b.

Looking now to FIG. 7E, an alternative solution for rank 2 transmissions is shown, where the first codeword 35a uses the first two columns of the precoding matrix after being passed through a splitter 36.

A number of problems are associated with antenna gain imbalance between antenna ports or antenna sites in the same cell of a radio base station, for instance
The estimation of the channel for both demodulation and for deriving channel state information from weaker antenna ports becomes very difficult and may result in corrupted CSI reporting, which will impair link adaptation and scheduling, as well as performance degradation in demodulation of PDSCH and EPDCCH.
The DL transmission to a wireless device from its associated weaker cross-pole may cause interference to wireless devices in other cells while the transmitted signal is very weak at the wireless device.
Since a codeword is transmitted from all four or eight antennas (based on the existing codebook), the link adaptation considers that a single codeword is transmitted using some “weak” ports and some other “strong” ports. The link adaptation of a given codeword takes into account also the weaker ports, leading to a loss in spectral efficiency. Also, the codewords are effectively mixed over the two cross-poles and this mixture makes it harder to at the receiver separate the two codewords in cases with highly imbalanced channels such as considered herein.

In one embodiment, the following occurs:
1> Grouping of the physical antennas (or CSI-RS antenna ports) belonging to the same radio base station into multiple “sites”, where each site contain at least two physical antennas/antenna ports and the sites are dislocated so that the path loss from one site can be significantly different to the path loss from another site.
2> Distribution using virtualization of antenna ports belonging to a radio base station to ensure that a reference signal used for measurements is transmitted from all sites (an important special case is here that the reference signal used to demodulate the transmitted data (i.e., the DMRS) is not transmitted from all sites but only from the site where data is transmitted from which gives good channel estimation performance for demodulation).
3> Deciding at the wireless device which the preferred precoding matrix and associated CQI and rank estimate and feeding back this information from the wireless device to the after CSI measurements on the virtualized antenna ports
4> Transmission of one or two codewords of the PDSCH so that a codeword (an important special case is here that a codeword corresponds to at least two layers) is transmitted from the at least two antenna ports at a single site only by applying a precoding from the standardized codebook on the virtual antenna ports.
5> Optional part: Subset selection of the resulting effective codebook after virtualization depending on the degree of AGI (antenna gain imbalance) experienced for the particular terminal
6> Optional part: Signalling of the subset to the particular terminal by codebook subset restriction alt. configuring two CSI processes with different codebook subset restrictions

Sites can be defined in one or more ways. Significantly, the use of antennas in different sites results in antenna gain imbalances in some situation. In one embodiment, the sites are geographically separated such that there is a significant difference in average path loss. In one embodiment, there is a difference in average path loss of at least 10 dB. In one embodiment, the sites are geographically separated by more than 10 metres. In one embodiment, each site comprises two (or an even number of) cross-polarised antennas.

A reference signal used for channel measurements, e.g., CSI-RS, is mapped to multiple or all the physical antennas used by the base station; see FIG. 8 where four CSI-RS signals 16a-d are mapped, in the most general case through the distribution matrix T 39, to four cross-pole antennas 13a-d which has been divided into two sites of one cross-pole each. The first port 17a and the third port 17c are both connected to a first site and the second port 17b and the fourth port 17d are both connected to a second site. The two sites can be widely spaced so that a wireless device close to one site will experience a large antenna gain imbalance of, e.g., port 1 with respect to port 2. Note that for wireless devices using CRS for measurements, then CSI-RS in FIG. 8 is replaced by CRS. The distribution is generally applicable for any reference signal used for measurements. It is to be noted that the CSI-RS signals do not need to be passed through the precoding matrix.

Multiple antenna ports can be obtained by using an orthogonal distribution matrix as is described further below. Since each reference signal, i.e., virtual antenna port, is transmitted from all physical antennas, or at least from one antenna in each of the two cross-poles in this example, the wireless device will measure the effective channel using, e.g., CSI-RS 1, as a combination of the channels from both sites, and thus all antenna ports will have approximately the same average received power. This is true despite the fact that a wireless device may be much closer to some physical antennas than others (antenna gain imbalance scenario). This is also beneficial for existing terminals that inherently assumes that channels measured on antenna ports belonging to the same base station have on average the same path loss, in 3GPP terminology, these antenna ports are quasi co-located with respect to antenna gain. Hence, the distribution above ensures such quasi co-location and terminal performance is expected to be enhanced in, e.g., these interleaved deployment scenarios.

FIG. 8 is a schematic diagram illustrating introduction of virtual antenna ports by the distribution matrix T for measurements. The four CSI-RS signals 16a-d are here sets of data defining the virtual antenna ports. A wireless device that is closer to site 1 than site 2 will experience a significant difference in the received power among the antenna ports of the base station.

FIG. 9 is a schematic diagram illustrating introduction of virtual antenna ports by the distribution matrix T for PDSCH transmission and possibly also DMRS transmission if applicable. A wireless device that is closer to site 1 than site 2 will experience a significant difference in the received power among the antenna ports of the base station.

In FIG. 9, the transmission of sets of data over PDSCH is shown, using a precoder W whose output is connected to the distribution T. Hence, the two codewords (each codeword being considered a set of data) will undergo a composite precoding using a composite precoding matrix TW. If DMRS based precoding is used, then also these demodulation reference signals are precoded with the composite precoding matrix TW.

Due to the method of grouping of antenna ports into sites, the use of the distribution matrix T, and possibly after pruning of some matrices W from the set of all matrices W in the 3GPP standardized codebook (of either Rel.8 or Rel.12), the codebook is transformed to an effective codebook that has the property that all codebook elements (i.e., matrices) ensures that a codeword belonging to the PDSCH transmission is mapped to at least two of the antenna ports at a single site only. Furthermore, since a PDSCH is mapped to at least two antenna ports, multiple layer transmission is still possible and by selection and feedback of the preferred W from the wireless device, some precoding gain is achieved (by co-phasing of the two antenna ports). This would not be possible if the composite precoding matrix TW would map a codeword to a single physical antenna only.

Furthermore, in one embodiment, define a first subset of the elements in the set of composite precoders. This subset constitute a set of precoders for CSI reporting that firstly satisfies mapping each measurement reference signal to all sites, hence approximately equal power property on all antenna ports, and secondly, these selected set of precoders maps a codeword to a single site. Hence, the mentioned set of composite precoders are useful when the wireless device is close to one of the cross-poles/sites since transmission of both codewords is effectively done from only one of the cross-poles/sites (and the other cross-pole is unused for the particular transmission). This will also improve the link adaptation since the channel from the antenna ports of the weak cross-pole/site is not included in the calculation of the spectral efficiency (CQI reporting).

Some embodiments presented herein further introduce a second subset of precoders in the effective codebook. This subset satisfies firstly that the mapping of all reference signals over all sites (possibly, but not necessarily, over all physical antennas) is achieved, and secondly, that these elements of the codebook maps a codeword to a single site only. If there are two codewords, they are mapped to different sites. Since link adaptation through modulation and code rate selection is done per codeword, a codeword transmitted from a “weak” cross-pole can use a robust modulation and coding whereas a codeword transmitted from a “strong” cross-pole can use more aggressive spectral efficiency. These composite precoders are useful when the wireless device is located in between the two cross-poles so that both cross-poles could be used but with independent link adaptation for the codewords.

Hence, mixing the layers of two different codewords are prevented from mixing onto imbalanced channels, thereby improving the possibility for the wireless device to separate the two codewords on the receive side.

Consequently, the first subset can be used with severe antenna gain imbalance (both codewords from a single site) and the second subset (each codeword from a different site) in case of less antenna gain imbalance. If there is no antenna gain imbalance (as if the wireless device is of equal path gain to the two cross-poles), then the whole codebook can be used as in normal operation (a codeword can then be mapped over all sites/all physical antennas).

Note that although terminology from 3GPP LTE has been used in this disclosure, this should not be seen as limiting the scope of protection to only the aforementioned system. Other wireless systems, including WCDMA, WiMAX, and UMB, may also benefit from exploiting the ideas covered within this disclosure.

Here now follows a description illustrating embodiments in more detail by a number of exemplary embodiments. It should be noted that these embodiments are not mutually exclusive. Components from one embodiment may be tacitly assumed to be present in another embodiment and it will be obvious to a person skilled in the art how those components may be used in the other exemplary embodiments.

For the following discussion, it is assumed that the physical antennas of a radio base station are not co-located, they are separated by some distance, e.g., an interleaved deployment as described above. They may however be grouped so that two physical antennas are physically co-located while another group of two antennas are geographically distant in a different site so that the path loss to the wireless device from different physical antennas are significantly different (also known as antenna gain imbalance). In the following, we will denote the antennas that are physically co-located as belonging to the same site. A common use case is a 4 Tx base station which use two sites of cross-polarized antennas (two physical antennas in each site).

In one embodiment the subset of the elements of the precoder codebook forms an effective codebook TW, where effectively a two port precoder codebook on one of the sites, or the other of the site, is achieved when the special distribution is applied. The benefit of having a two port composite precoder (as opposed to a single antenna port composite precoder) is that co-phasing is possible, i.e., it is possible to achieve precoding gain. Another benefit is that rank two transmissions are possible also in the case of antenna gain imbalance, which will improve the user throughput. Hence, in this embodiment, only one site is used in the actual transmission of data and the wireless device will estimate the CQI based on the composite precoder TW and assume PDSCH transmission from one site (due to the design of T and resulting composite precoding matrix) in feedback of preferred CQI.

In a further embodiment, the elements (i.e., matrices) of the effective codebook contains disjunctive subsets of elements that maps to different cross-poles that in turn may be widely separated. Hence, by the terminal will select, by CSI reporting, which cross-pole it prefers to receive transmission from and solely the selected cross-pole will be used. This is useful in case the AGI is very large as when a terminal is very close to one of the cross-poles. For example, assuming a 4TX system, the actual precoding matrix could have this structure (where possibly scaling of the resulting matrix with a complex scalar has been omitted):

$$T W = [ \begin{matrix}1 & 1 \\ 0 & 0 \\ α & - α \\ 0 & 0\end{matrix} ] , \qquad ( 14 )$$

where only port 1 and 3 are used in the actual transmission of both CW1 (first column) and CW2 (second column), and where alpha is a constant that depends on the details of T and W. Depending on which W the wireless device selects, there will be different values on the parameter alpha, which implies that co-phasing gains are possible to achieve.

Alternatively, the matrix can have this structure:

$$T W = [ \begin{matrix}0 & 0 \\ 1 & 1 \\ 0 & 0 \\ α & - α\end{matrix} ] . \qquad ( 15 )$$

The wireless device will, through the feedback of the preferred precoding matrix W, select whether port 1+3 or port 2+4 should be used for the PDSCH transmission. Hence, the wireless device can mitigate large antenna gain imbalances simply by using the standardized framework of PMI feedback.

In another embodiment, when considering composite precoders for ranks higher than or equal to 2, the codebook contains subsets of composite precoders that maps different codewords to separate cross-poles when using the special distribution. Since link adaptation is independent per codeword, this allow for AGI mitigation. For example, assuming a 4TX system and rank 2 transmission, the actual precoding matrix could have these structures:

$$T W = [ \begin{matrix}1 & 0 \\ 0 & 1 \\ α & 0 \\ 0 & β\end{matrix} ] or T W = [ \begin{matrix}0 & 1 \\ 1 & 0 \\ 0 & β \\ α & 0\end{matrix} ] , \qquad ( 16 )$$

where only port 1 and 3 are used in the actual transmission of CW1. (first column) and port 2 and 4 are used to transmit CW2 (second column) (or vice versa for the second matrix), and where alpha and beta are variables that depend on the details of T and W and is under the control of the wireless device, by proper selection of W. Hence, precoding, or co-phasing gains, can be achieved. This example can be further expanded to a rank 3 transmission:

$$T W = [ \begin{matrix}1 & 0 & 0 \\ 0 & 1 & 1 \\ α & 0 & 0 \\ 0 & β & - β\end{matrix} ] , \qquad ( 17 )$$

where CW 1 (first column) maps to port 1 and 3 (first cross-pole) and CW 2 maps to port 2 and 4 (second cross-pole).

In one embodiment, if the transmitter is equipped with four antennas consisting of two widely separated cross-poles, the special distribution mixes the ports defined by the reference signals that belong to the same polarization using a two by two Hadamard matrix or a discrete Fourier transform (DFT) matrix. For example if the antenna ports are indexed as follows:

| Antenna | | Cross- |
|---|---|---|
| port index | Polarization | pole/Site |
| 1 | A | 1 |
| 2 | A | 2 |
| 3 | B | 1 |
| 4 | B | 2 |

then the special distribution matrix, which is compliant with the 3GPP LTE Rel.8 and Rel.12 codebooks, equals to

$$T = \frac{1}{\sqrt{2}} [ \begin{matrix}1 & 1 & 0 & 0 \\ 1 & - 1 & 0 & 0 \\ 0 & 0 & 1 & 1 \\ 0 & 0 & 1 & - 1\end{matrix} ] . \qquad ( 18 )$$

Note that row and/or column permutations of this matrix are also possible and still give the claimed benefits. For instance, row 2 and 4 can be exchanged.

For instance, antenna port 1 is transmitted from physical antenna 1 and 2, having the same polarization (in this example, but this is optional), through the distribution [1 1] and port 2 is also transmitted from antenna 1 and 2 with distribution [1−1] which means that the phase on the second antenna is adjusted by 180 degrees. In the case of large AGI, port 1 and port 2 will both be transmitted from both cross-poles 1 and 2 at different sites according to the table. The same holds for port 3 and 4 and it can be shown that all antenna ports will be received at the wireless device with approximately same average power since each antenna port is distribution over two antennas belonging to different sites.

In the following embodiments it is assumed that the above (18) distribution T is used together with the above defined ordering of antenna ports.

A more generic approach to design T for an N antenna system (N=2, 4, 8) when W has the dual codebook structure (2) and when the conversion precoder is block diagonal as in (3):

$${W}^{( c )} = [ \begin{matrix}{\tilde{W}}^{( c )} & 0 \\ 0 & {\tilde{W}}^{( c )}\end{matrix} ] \qquad ( 19 )$$

can be achieved by the following steps:
1. Select N orthogonal vectors from the codebook \tilde{W}^{(c)} for instance by selecting the first column of \tilde{W}^{(c)} from different \tilde{W}^{(c)} matrices until an orthogonal set has been found.
2. Denote this orthogonal vector set as wₐ_{₁}, wₐ_{₂}, . . . , wₐ_{_{N}}.
3. Form the matrix T′=[wₐ_{₁} wₐ_{₂} . . . wₐ_{_{N}}]^{H} where [ ]^{H} is the Hermitian transpose.
4. Form the distribution matrix as this block diagonal matrix

$$T = [ \begin{matrix}{T}^{′} & 0 \\ 0 & {T}^{′}\end{matrix} ] .$$

Now, due to this structure

$$T [ \begin{matrix}{w}_{i} \\ α {w}_{i}\end{matrix} ] = [ \begin{matrix}{e}_{i} \\ α {e}_{i}\end{matrix} ]$$

for some of the rank 1 precoders i=aⱼ, where eᵢ is a vector that contains only zeroes except a single non zero element in the i:th row. Due to the antenna port numbering where port x and x+N/2 belongs to the same cross-pole (e.g., 1 and 3 for N=4 antennas and 1 and 5 for N=8 antennas), this distribution together with the precoding vectors of structure

$$[ \begin{matrix}{w}_{i} \\ α {w}_{i}\end{matrix} ]$$

ensure that the codeword is transmitted from only one of the N/2 cross-poles only. Hence, this is useful in large AGI cases, when only one of the sites or cross-poles should be used for the transmission.

A common rank 2 structure in the dual codebook structure design, applicable for 8Tx LTE and under discussion also for 4TX Rel.12 LTE is this

$$[ \begin{matrix}{w}_{i} & {w}_{i} \\ α {w}_{i} & - α {w}_{i}\end{matrix} ] . \qquad ( 20 )$$

This, together with the distribution matrix obtained from the steps above, gives

$$T [ \begin{matrix}{w}_{i} & {w}_{i} \\ α {w}_{i} & - α {w}_{i}\end{matrix} ] = [ \begin{matrix}{e}_{i} & {e}_{i} \\ α {e}_{i} & - α {e}_{i}\end{matrix} ] . \qquad ( 21 )$$

Hence, both codewords (both columns) are transmitted from the same site also in this case, useful for the large AGI case when only one site is preferred to be used.

Another case of a rank 2 codebook is this structure:

$$[ \begin{matrix}{w}_{i} & {w}_{k} \\ α {w}_{i} & β {w}_{k}\end{matrix} ] , \qquad ( 22 )$$

where wᵢ and wₖ are orthogonal. Applying the distribution matrix in this case

$$T [ \begin{matrix}{w}_{i} & {w}_{k} \\ α {w}_{i} & β {w}_{k}\end{matrix} ] = [ \begin{matrix}{e}_{i} & {e}_{k} \\ α {e}_{i} & β {e}_{k}\end{matrix} ] \qquad ( 23 )$$

and since i≠k, the first codeword (CW1) of the first column is mapped to a different site or cross-pole than the other codeword (CW2) of the second column. This is useful to obtain independent link adaptation of the two codewords since they are mapped to individual sites.

The principle can be extended to higher ranks and will provide a solution to the problem as long as the rank 1 precoding vectors, used to create the T matrix, are also used as columns in higher rank precoding matrices. This was clear from the second part of the rank 2 example above, where wₖ was also a rank 1 precoding vector (and hence included in the design of T).

### Detailed Embodiment for Rank 1

In a further detailed refinement of the above embodiment the codebook of precoders contains at least the following elements for rank 1 (which is a subset of the 16 available precoding vectors in the 3GPP LTE Rel.8 codebook)

$$W = [ \begin{matrix}1 \\ 1 \\ 1 \\ 1\end{matrix} ] , [ \begin{matrix}1 \\ 1 \\ j \\ j\end{matrix} ] , [ \begin{matrix}1 \\ 1 \\ - 1 \\ - 1\end{matrix} ] , [ \begin{matrix}1 \\ 1 \\ - j \\ - j\end{matrix} ] , [ \begin{matrix}1 \\ - 1 \\ 1 \\ - 1\end{matrix} ] , [ \begin{matrix}1 \\ - 1 \\ j \\ - j\end{matrix} ] , [ \begin{matrix}1 \\ - 1 \\ - 1 \\ 1\end{matrix} ] , [ \begin{matrix}1 \\ - 1 \\ - j \\ j\end{matrix} ] \qquad ( 24 )$$

When the distribution matrix T from (18) is applied on these codewords, then only antenna port index 1 and 3 or 2 and 4 will transmit the codeword. Hence, this can be used at large AGI, since the two used physical antennas are at the same site.

Alternatively, the effective codebook can have this form (which is proposed for 3GPP LTE Rel.12 codebook when there are four CSI-RS antenna ports)

Where e₁=[1 0 0 0]^{T}, e₂=[0 1 0 0]^{T}, e₃=[0 0 1 0]^{T} and e₄=[0 0 0 1]^{T}.

Some of the rank 1 codewords in this Rel.12 codebook are of the form

$$\begin{matrix}{W}_{n , m} = [ \begin{matrix}1 \\ 1 \\ 1 \\ 1\end{matrix} ] , [ \begin{matrix}1 \\ - 1 \\ z \\ - z\end{matrix} ] , [ \begin{matrix}1 \\ 1 \\ j \\ j\end{matrix} ] , [ \begin{matrix}1 \\ - 1 \\ - {z}^{*} \\ {z}^{*}\end{matrix} ] , [ \begin{matrix}1 \\ 1 \\ - 1 \\ - 1\end{matrix} ] , [ \begin{matrix}1 \\ - 1 \\ - z \\ z\end{matrix} ] , [ \begin{matrix}1 \\ 1 \\ - j \\ - j\end{matrix} ] , & ( 25 ) \\ [ \begin{matrix}1 \\ - 1 \\ {z}^{*} \\ - {z}^{*}\end{matrix} ] , [ \begin{matrix}1 \\ - 1 \\ x \\ - x\end{matrix} ] , [ \begin{matrix}1 \\ 1 \\ y \\ y\end{matrix} ] , [ \begin{matrix}1 \\ - 1 \\ - {y}^{*} \\ {y}^{*}\end{matrix} ] , [ \begin{matrix}1 \\ 1 \\ - {x}^{*} \\ - {x}^{*}\end{matrix} ] , [ \begin{matrix}1 \\ - 1 \\ - x \\ x\end{matrix} ] , [ \begin{matrix}1 \\ 1 \\ - y \\ - y\end{matrix} ] , & \\ [ \begin{matrix}1 \\ - 1 \\ {y}^{*} \\ - {y}^{*}\end{matrix} ] , [ \begin{matrix}1 \\ 1 \\ {x}^{*} \\ {x}^{*}\end{matrix} ] , & \end{matrix}$$

where z=q₁⁴, x=q₁², y=q₁⁶. More generally, these rank 1 codewords are of the form

$${W}_{n , m} = [ \begin{matrix}1 \\ 1 \\ a \\ a\end{matrix} ] or {W}_{n , m} = [ \begin{matrix}1 \\ - 1 \\ a \\ - a\end{matrix} ] , \qquad ( 26 )$$

where a is a complex number.

When the distribution matrix T from (18) is multiplied with any the codewords in the Rel.12 codebook listed above (this list show not necessarily not all codewords in the codebook having this property), then again, only antenna port index 1 and 3 or 2 and 4 will transmit the codeword and the different rank 1 codebook alternatives gives selection with different phase angles between the two selected antenna ports. Hence, this can be used at large AGI, since the two used antenna ports are using the same cross-pole. At smaller or negligible AGI, then other values of n,m in the selection of W_{n,m} (i.e., precoding vectors that don't give the property described above) can be used, which implies that the codewords are mapped to all four antenna ports.

### Detailed Embodiment Rank 2, Map to Single Cross-Pole

In another further refined embodiment the codebook of precoders contains at least the following elements for rank 2 (which is a subset of the 16 available precoding vectors in the 3GPP LTE Rel.8 codebook)

$$W = [ \underline{\begin{matrix}1 & 1 \\ 1 & 1 \\ 1 & - 1 \\ 1 & - 1\end{matrix}} ] , [ \underline{\begin{matrix}1 & 1 \\ 1 & 1 \\ j & - j \\ j & - j\end{matrix}} ] , [ \underline{\begin{matrix}1 & 1 \\ - 1 & - 1 \\ 1 & - 1 \\ - 1 & 1\end{matrix}} ] , [ \underline{\begin{matrix}1 & 1 \\ - 1 & - 1 \\ j & - j \\ - j & j\end{matrix}} ] , \qquad ( 27 )$$

where the first two composite precoders (after multiplying with T, i.e., T*W) maps the both codewords (i.e., column 1 and 2) to the first cross-pole (port 1 and 3) and the second two precoders maps both codewords to the second cross-pole (port 2 and 4). Hence, this can be used at severe AGI, when only one cross-pole should be engaged in the transmission. For instance, the first matrix gives

$$TW = T [ \underline{\begin{matrix}1 & 1 \\ 1 & 1 \\ 1 & - 1 \\ 1 & - 1\end{matrix}} ] = [ \underline{\begin{matrix}2 & 2 \\ 0 & 0 \\ 2 & - 2 \\ 0 & 0\end{matrix}} ] , \qquad ( 28 )$$

where it can be seen that the first codeword maps to antenna port index 1 and 3 (first column), and the second codeword maps also to antenna port index 1 and 3 (second column) but with a 180 degree phase shift of the transmission of the second codeword from antenna port index 3.

Alternatively, the codebook can have this second form (which is under discussion for 3GPP LTE Rel.12 codebook)

$${W}_{1 , n} = [ \begin{matrix}{X}_{n} & 0 \\ 0 & {X}_{n}\end{matrix} ] where n = 0 , 1 , … , 15$$

$${X}_{n} = [ \begin{matrix}1 & 1 & 1 & 1 \\ {q}_{1}^{n} & {q}_{1}^{n + 8} & {q}_{1}^{n + 16} & {q}_{1}^{n + 24}\end{matrix} ] where {q}_{1} = {e}^{j2 π / 32}$$

$${W}_{2 , n} ∈ \{ \frac{1}{2} [ \begin{matrix}{Y}_{1} & {Y}_{2} \\ {Y}_{1} & {Y}_{2}\end{matrix} ] , \frac{1}{2} [ \begin{matrix}{Y}_{1} & {Y}_{2} \\ {Y}_{1} & - {Y}_{2}\end{matrix} ] , \frac{1}{2} [ \begin{matrix}{Y}_{1} & {Y}_{2} \\ - {Y}_{1} & {Y}_{2}\end{matrix} ] , \frac{1}{2} [ \begin{matrix}{Y}_{1} & {Y}_{2} \\ - {Y}_{1} & - {Y}_{2}\end{matrix} ] \}$$

$$( {Y}_{1} , {Y}_{2} ) ∈ \{ ( {e}_{2} , {e}_{4} ) \}$$

$$and$$

$${W}_{2 , n} ∈ \{ \frac{1}{2} [ \begin{matrix}{Y}_{1} & {Y}_{2} \\ {Y}_{1} & - {Y}_{2}\end{matrix} ] , \frac{1}{2} [ \begin{matrix}{Y}_{1} & {Y}_{2} \\ j {Y}_{1} & - j {Y}_{2}\end{matrix} ] \}$$

$$( {Y}_{1} , {Y}_{2} ) ∈ \{ ( {e}_{1} , {e}_{1} ) , ( {e}_{2} , {e}_{2} ) , ( {e}_{3} , {e}_{3} ) , ( {e}_{4} , {e}_{4} ) \}$$

$$and$$

$${W}_{2 , n} ∈ \{ \frac{1}{2} [ \begin{matrix}{Y}_{1} & {Y}_{2} \\ {Y}_{2} & - {Y}_{1}\end{matrix} ] , \} ( {Y}_{1} , {Y}_{2} ) ∈ \{ ( {e}_{1} , {e}_{3} ) , ( {e}_{2} , {e}_{4} ) , ( {e}_{3} , {e}_{1} ) , ( {e}_{4} , {e}_{2} ) \}$$

A matrix in the codebook is then given as W_{n,m}=W_{1,n}W_{2,m} (29)

where e₁=[1 0 0 0]_{T}, e₂=[0 1 0 0]^{T}, e₃=[0 0 1 0]^{T} and e₄=[0 0 0 1]^{T}.

Some of the rank 2 matrices in this rank 2 codebook proposal for Rel.12 are these

$${W}_{n , m} = {W}_{1 , n} {W}_{2 , m} = [ \underline{\begin{matrix}1 & 1 \\ 1 & 1 \\ 1 & - 1 \\ 1 & - 1\end{matrix}} ] , [ \underline{\begin{matrix}1 & 1 \\ - 1 & - 1 \\ 1 & - 1 \\ - 1 & 1\end{matrix}} ] , [ \underline{\begin{matrix}1 & 1 \\ 1 & 1 \\ j & - j \\ j & - j\end{matrix}} ] , [ \underline{\begin{matrix}1 & 1 \\ - 1 & - 1 \\ j & - j \\ - j & j\end{matrix}} ] , [ \underline{\begin{matrix}1 & 1 \\ - 1 & - 1 \\ 1 & - 1 \\ - 1 & 1\end{matrix}} ] . \qquad ( 30 )$$

The composite precoders (after multiplying with T, i.e., T*W) maps the both codewords (i.e., column 1 and 2) to either the first cross-pole (port 1 and 3) or to the second cross-pole (port 2 and 4).

An alternative for a rank 2 codebook which if being considered for Rel.12 has the same W_{1,n} codebook as the second codebook described above but a slightly different W_{2,m} codebook:

$${W}_{2 , n} ∈ \{ \frac{1}{2} [ \begin{matrix}{Y}_{1} & {Y}_{2} \\ {Y}_{1} & - {Y}_{2}\end{matrix} ] , \frac{1}{2} [ \begin{matrix}{Y}_{1} & {Y}_{2} \\ {jY}_{1} & - {jY}_{2}\end{matrix} ] \} and \\ ( {Y}_{1} , {Y}_{2} ) = ( {e}_{i} , {e}_{k} ) ∈ \{ \begin{matrix}( {e}_{1} , {e}_{1} ) , ( {e}_{2} , {e}_{2} ) , ( {e}_{3} , {e}_{3} ) , ( {e}_{4} , {e}_{4} ) , \\ ( {e}_{1} , {e}_{2} ) , ( {e}_{2} , {e}_{3} ) , ( {e}_{1} , {e}_{4} ) , ( {e}_{2} , {e}_{4} )\end{matrix} \} ; . \qquad ( 31 )$$

Some of the rank 2 matrices in this rank 2 codebook proposal for Rel.12 are these

$${W}_{n , m} = {W}_{1 , n} {W}_{2 , m} = [ \begin{matrix}1 & 1 \\ 1 & 1 \\ 1 & - 1 \\ 1 & - 1\end{matrix} ] , [ \begin{matrix}1 & 1 \\ - 1 & - 1 \\ 1 & - 1 \\ - 1 & 1\end{matrix} ] , [ \begin{matrix}1 & 1 \\ 1 & 1 \\ j & - j \\ j & - j\end{matrix} ] , [ \begin{matrix}1 & 1 \\ - 1 & - 1 \\ j & - j \\ - j & j\end{matrix} ] , [ \begin{matrix}1 & 1 \\ - 1 & - 1 \\ 1 & - 1 \\ - 1 & 1\end{matrix} ] , \qquad ( 32 )$$

The composite precoders (after multiplying with T, i.e., T*W) maps the both codewords (i.e., column 1 and 2) to either the first cross-pole (port 1 and 3) or to the second cross-pole (port 2 and 4).

Hence, these codebook elements described in this section can be used at severe AGI, when only one cross-pole should be engaged in the rank 2 transmission. At negligible AGI, then other values of n, m in the selection of W_{1,n} W_{2,m} can be used, which implies that the codeword are mapped to all antenna ports.

### Detailed Embodiment Rank 2, Map Each Codeword to Different Cross-Poles

In another embodiment the codebook of precoders contains at least the following elements for rank 2 (which is a subset of the 16 available precoding vectors in the 3GPP LTE Rel.8 codebook)

$$W = [ \begin{matrix}1 & 1 \\ 1 & - 1 \\ 1 & 1 \\ 1 & - 1\end{matrix} ] , [ \begin{matrix}1 & 1 \\ 1 & - 1 \\ - 1 & 1 \\ - 1 & - 1\end{matrix} ] , [ \begin{matrix}1 & 1 \\ 1 & - 1 \\ 1 & - 1 \\ 1 & 1\end{matrix} ] , [ \begin{matrix}1 & 1 \\ 1 & - 1 \\ - 1 & - 1 \\ - 1 & 1\end{matrix} ] , \qquad ( 33 )$$

where the different columns represent different codewords, and where each codeword will be transmitted from different cross-poles. For instance, the first matrix gives

$$T W = T [ \begin{matrix}1 & 1 \\ 1 & - 1 \\ 1 & 1 \\ 1 & - 1\end{matrix} ] = [ \begin{matrix}2 & 0 \\ 0 & 2 \\ 2 & 0 \\ 0 & 2\end{matrix} ] , \qquad ( 34 )$$

where it can be seen that the first codeword maps to antenna port index 1 and 3 (first column), and the second codeword maps to antenna port index 2 and 4 (second column). This can be used when AGI is less severe, but link adaptation per codewords is desirable. Since the first codeword is mapped to one cross-pole, and the other to the other cross-pole, the per codeword link adaptation, which already is part of LTE Rel.8, can be re-used without modification. Another use for this mapping is when AGI is non-negligible while the SNR level is high to mitigate inter-codeword interference by avoiding mixing the codewords across channel dimensions of widely different strength.

Alternatively, the codebook can have this second form (which is under discussion for a 3GPP LTE Rel.12 codebook)

$${W}_{1 , n} = [ \begin{matrix}{X}_{n} & 0 \\ 0 & {X}_{n}\end{matrix} ] where n = 0 , 1 , … , 15$$

$${X}_{n} = [ \begin{matrix}1 & 1 & 1 & 1 \\ {q}_{1}^{n} & {q}_{1}^{n + 8} & {q}_{1}^{n + 16} & {q}_{1}^{n\_ 24}\end{matrix} ] where {q}_{1} = {e}^{j 2 π / 32}$$

$${W}_{2 , m} ∈ \{ \frac{1}{2} [ \begin{matrix}{Y}_{1} & {Y}_{2} \\ {Y}_{1} & {Y}_{2}\end{matrix} ] , \frac{1}{2} [ \begin{matrix}{Y}_{1} & {Y}_{2} \\ {Y}_{1} & - {Y}_{2}\end{matrix} ] , \frac{1}{2} [ \begin{matrix}{Y}_{1} & {Y}_{2} \\ - {Y}_{1} & {Y}_{2}\end{matrix} ] , \frac{1}{2} [ \begin{matrix}{Y}_{1} & {Y}_{2} \\ - {Y}_{1} & - {Y}_{2}\end{matrix} ] \} ( {Y}_{1} , {Y}_{2} ) ∈ \{ ( {e}_{2} , {e}_{4} ) \}$$

$$and$$

$${W}_{2 , m} ∈ \{ \frac{1}{2} [ \begin{matrix}{Y}_{1} & {Y}_{2} \\ {Y}_{1} & - {Y}_{2}\end{matrix} ] , \frac{1}{2} [ \begin{matrix}{Y}_{1} & {Y}_{2} \\ {jY}_{1} & - {jY}_{2}\end{matrix} ] \} ( {Y}_{1} , {Y}_{2} ) ∈ \{ ( {e}_{1} , {e}_{1} ) , ( {e}_{2} , {e}_{2} ) , ( {e}_{3} , {e}_{3} ) , ( {e}_{4} , {e}_{4} ) \}$$

$$and$$

$${W}_{2 , m} ∈ \{ \frac{1}{2} [ \begin{matrix}{Y}_{1} & {Y}_{2} \\ {Y}_{2} & - {Y}_{1}\end{matrix} ] , \} ( {Y}_{1} , {Y}_{2} ) ∈ \{ ( {e}_{1} , {e}_{3} ) , ( {e}_{2} , {e}_{4} ) , ( {e}_{3} , {e}_{1} ) , ( {e}_{4} , {e}_{2} ) \}$$

A matrix in the codebook is then given as W_{n,m}=W_{1,n}W_{2,m} (35)

where e₁=[1 0 0 0]^{T}, e₂=[0 1 0 0]^{T}, e₃=[0 0 1 0]^{T} and e₄=[0 0 0 1]^{T}.

Some of the rank 2 matrices in this codebook proposal for Rel.12 described above are these

$${W}_{n , m} = [ \begin{matrix}1 & 1 \\ - 1 & 1 \\ 1 & 1 \\ - 1 & 1\end{matrix} ] , [ \begin{matrix}1 & 1 \\ - 1 & 1 \\ 1 & - 1 \\ - 1 & - 1\end{matrix} ] , [ \begin{matrix}1 & 1 \\ - 1 & 1 \\ - 1 & 1 \\ 1 & 1\end{matrix} ] , [ \begin{matrix}1 & 1 \\ - 1 & 1 \\ - 1 & - 1 \\ 1 & - 1\end{matrix} ] , \qquad ( 36 )$$

where the composite precoders (after multiplying with T from (18), i.e., T*W) maps the first codeword to antenna port index 1 and 3 (second column), and the second codeword maps to antenna port index 2 and 4 (first column) or alternatively, the first codeword to antenna port 2 and 4 and the second codeword to antenna port 1 and 3. This can be used when AGI is less severe, but link adaptation per codewords is desirable. Since the first codeword is mapped to one cross-pole, and the other to the other cross-pole, the per codeword link adaptation, which already is part of LTE Rel.8, can be re-used without modification. At smaller or negligible AGI, then other values of n, m in the selection of W_{n,m} can be used, which implies that the codewords are mapped to all antenna ports.

A third alternative for a rank 2 codebook for consideration in Rel.12 has a slightly different W_{2,m} codebook but the same W_{1,n} codebook as the Rel.12 codebook proposal (second form) above:

$${W}_{2 , m} ∈ \{ \frac{1}{2} [ \begin{matrix}{Y}_{1} & {Y}_{2} \\ {Y}_{1} & - {Y}_{2}\end{matrix} ] , \frac{1}{2} [ \begin{matrix}{Y}_{1} & {Y}_{2} \\ {jY}_{1} & - {jY}_{2}\end{matrix} ] \} and \\ ( {Y}_{1} , {Y}_{2} ) = ( {e}_{i} , {e}_{k} ) ∈ \{ \begin{matrix}( {e}_{1} , {e}_{1} ) , ( {e}_{2} , {e}_{2} ) , ( {e}_{3} , {e}_{3} ) , ( {e}_{4} , {e}_{4} ) , \\ ( {e}_{1} , {e}_{2} ) , ( {e}_{2} , {e}_{3} ) , ( {e}_{1} , {e}_{4} ) , ( {e}_{2} , {e}_{4} )\end{matrix} \} ; . \qquad ( 37 )$$

Some of the rank 2 matrices in this third codebook, which is a proposal for Rel.12 are these:

$${W}_{n , m} = [ \begin{matrix}1 & 1 \\ - 1 & 1 \\ - 1 & - 1 \\ 1 & - 1\end{matrix} ] , [ \begin{matrix}1 & 1 \\ - 1 & 1 \\ j & - j \\ - j & - j\end{matrix} ] , \qquad ( 38 )$$

where the composite precoders (after multiplying with T from (18), i.e., T*W) maps the first codeword to antenna port index 1 and 3 (second column), and the second codeword maps to antenna port index 2 and 4 (first column). This can be used when AGI is less severe, but link adaptation per codewords is desirable. Since the first codeword is mapped to one cross-pole, and the other to the other cross-pole, the per codeword link adaptation, which already is part of LTE Rel.8, can be re-used without modification. At smaller or negligible AGI, then other values of n, m in the selection of W_{n,m} can be used, which implies that the codewords are mapped to all antenna ports.

### Detailed Embodiment Rank 3

In another further refined embodiment the codebook of precoders contains at least the following elements for rank 3 (which is a subset of the 16 available precoding vectors in the 3GPP LTE Rel.8 codebook as well as in the LTE Rel.12 codebook)

$$W = [ \begin{matrix}1 & 1 & 1 \\ 1 & - 1 & - 1 \\ 1 & - 1 & 1 \\ 1 & 1 & - 1\end{matrix} ] , [ \begin{matrix}1 & 1 & 1 \\ 1 & - 1 & - 1 \\ j & - 1 & 1 \\ j & 1 & - 1\end{matrix} ] , [ \begin{matrix}1 & 1 & 1 \\ 1 & - 1 & - 1 \\ - 1 & - 1 & 1 \\ - 1 & 1 & - 1\end{matrix} ] , [ \begin{matrix}1 & 1 & 1 \\ 1 & - 1 & - 1 \\ - j & - 1 & 1 \\ - j & 1 & - 1\end{matrix} ] , \qquad ( 39 )$$

where, for all composite precoders, the first column (that represents the first codeword) maps to the first cross-pole and the second and third columns (that represents the second codeword) maps to the second cross-pole.

Hence, per codeword link adaptation is possible where a codeword under large AGI has either a weak or a strong link.

### Detailed Embodiment Rank 4

In another further refined embodiment the codebook of precoders contains at least the following element for rank 4 (which is a subset of the 16 available precoding vectors in the 3GPP LTE Rel.8 codebook as well as in the LTE Rel.12 codebook)

$$W = [ \begin{matrix}1 & 1 & 1 & 1 \\ 1 & 1 & - 1 & - 1 \\ 1 & - 1 & - 1 & 1 \\ 1 & - 1 & 1 & - 1\end{matrix} ] , [ \begin{matrix}1 & 1 & 1 & 1 \\ 1 & 1 & - 1 & - 1 \\ j & - j & - 1 & 1 \\ j & - j & 1 & - 1\end{matrix} ] , [ \begin{matrix}1 & 1 & 1 & 1 \\ 1 & 1 & - 1 & - 1 \\ 1 & - 1 & - j & j \\ 1 & - 1 & j & - j\end{matrix} ] , [ \begin{matrix}1 & 1 & 1 & 1 \\ 1 & 1 & - 1 & - 1 \\ j & - j & - j & j \\ j & - j & j & - j\end{matrix} ] , \qquad ( 40 )$$

where, for the composite precoder, the first and second column (that represents the first codeword) maps to the first cross-pole and the third and fourth columns (that represents the second codeword) maps to the second cross-pole. Hence, per codeword link adaptation becomes efficient.

### Embodiment, Codebook Subset Restriction

In this embodiment, the radio base station configures the wireless device which codebook elements that is which indices {n, m}, to use for its CQI and PMI reporting and the codebook subset is restricted to the effective codebook as described in the previous embodiments for rank 1-4 as to ensure that the wireless device only reports the codewords that after application of the distribution matrix maps to the cross-poles in the desired manner. Hence, it is possible to ensure that the wireless device only reports CQI and PMI for precoding matrices that maps one codeword to a single site. When wireless device reports a rank higher than one, engaging two codewords, it is possible to ensure, by codebook subset restriction, that CQI and PMI are feed back assuming that both codewords are transmitted from the same site or each codeword is transmitted from a different site according to the embodiments above.

Restriction is achieved by the feature and related RRC signaling of codebook subset restriction described in TS 36.213 and TS 36.331.

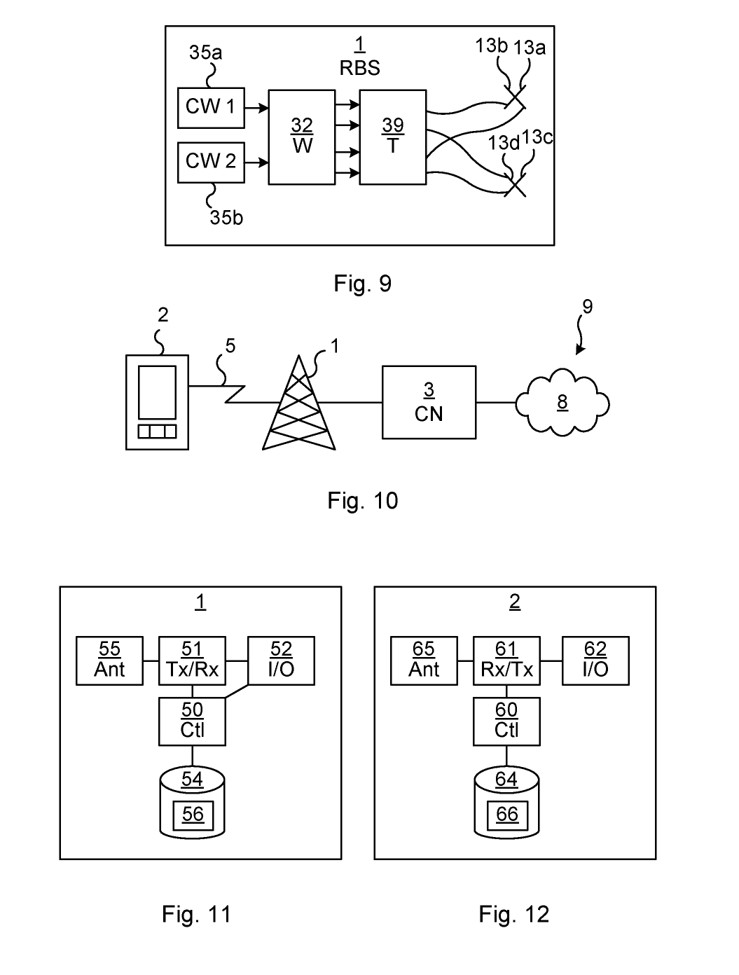

FIG. 10 is a schematic diagram illustrating an environment where embodiments presented herein can be applied. A mobile communications network 9 comprises a core network 3 and a radio access network comprising one or more radio base stations 1 and optionally one or more radio network controllers (not shown). The radio base stations 1 are here in the form of evolved Node Bs also known as eNBs but could also be in the form of Node Bs (NodeBs/NBs) and/or BTSs (Base Transceiver Stations) and/or BSSs (Base Station Subsystems), etc. The radio base stations 1 provide radio connectivity to a plurality of wireless devices 2. The term wireless device is also known as user equipment (UE), mobile terminal, user terminal, user agent, etc.

Each one of the radio base stations 1 provides radio coverage in one or more respective radio cells. Uplink (UL) communication, from the wireless device 2 to the radio base station 1, and downlink (DL) communication, from the radio base station 1 to the wireless device 2 occur over a wireless radio interface 5. The radio conditions of the wireless radio interface 5 vary over time and also depend on the position of the wireless device 2, due to effects such as interference, fading, multipath propagation, etc.

The core network 3 provides access to central functions in the mobile communication network and connectivity to other communication networks 8.

The mobile communications network 9 may, e.g., comply with any one or a combination of LTE (Long Term Evolution), UMTS utilising W-CDMA (Wideband Code Division Multiplex), CDMA2000 (Code Division Multiple Access 2000), or any other current or future wireless network, as long as the principles described hereinafter are applicable. Nevertheless, LTE will be used below to fully illustrate a context in which embodiments presented herein can be applied.

FIG. 11 is a schematic diagram showing some components of the radio base station 1 of FIGS. 8 to 10. A processor 50 is provided using any combination of one or more of a suitable central processing unit (CPU), multiprocessor, microcontroller, digital signal processor (DSP), application specific integrated circuit etc., capable of executing software instructions 56 stored in a memory 54, which can thus be a computer program product. The processor 50 can be configured to execute the method described with reference to FIGS. 7A-B above.

The memory 54 can be any combination of read and write memory (RAM) and read only memory (ROM). The memory 54 also comprises persistent storage, which, for example, can be any single one or combination of magnetic memory, optical memory, solid state memory or even remotely mounted memory.

The radio base station 1 further comprises an I/O interface 52 for communicating with the core network and optionally with other radio base stations.

The radio base station 1 also comprises one or more transceivers 51, comprising analogue and digital components, and a suitable number of antennas 55 (including at least two receive antennas) for radio communication with wireless devices within one or more radio cells. The antennas 55 can be distributed over several sites, even if they belong to the same cell. Same cell is here to be interpreted as having the same cell identifier. The processor 50 controls the general operation of the radio base station 1, e.g., by sending control signals to the transceiver 51 and receiving reports from the transceiver 51 of its operation. In one embodiment, the I/O interface 52 is directly connected to the transceiver 51, whereby data to and from the core network is directly routed between the I/O interface 52 and the transceiver 51.

Other components of the radio base station 1 are omitted in order not to obscure the concepts presented herein.

FIG. 12 is a schematic diagram showing some components of the wireless device 2 of FIGS. 8 to 10. A processor 60 is provided using any combination of one or more of a suitable central processing unit (CPU), multiprocessor, microcontroller, digital signal processor (DSP), application specific integrated circuit etc., capable of executing software instructions 66 stored in a memory 64, which can thus be a computer program product.

The memory 64 can be any combination of read and write memory (RAM) and read only memory (ROM). The memory 64 also comprises persistent storage, which, for example, can be any single one or combination of magnetic memory, optical memory, solid state memory or even remotely mounted memory.

The wireless device 2 further comprises an I/O interface. The I/O interface can comprise a user interface including a display, input devices (keypads, touch sensitivity of the screen, etc.), speaker, microphone, etc.

The wireless device 2 also comprises one or more transceivers 61, comprising analogue and digital components, and a suitable number of antennas 65 for radio communication with radio base stations. The processor 6o controls the general operation of the wireless device 2, e.g., by sending control signals to the transceiver 61 and receiving reports from the transceiver 61 of its operation.

Other components of the wireless device 2 are omitted in order not to obscure the concepts presented herein.

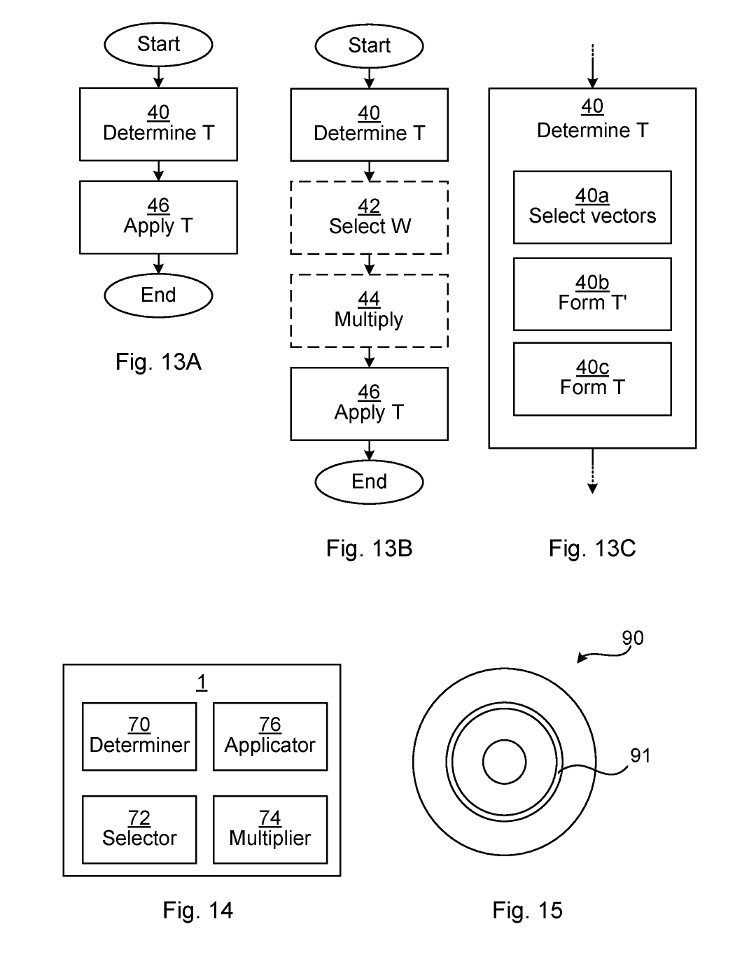

FIGS. 13 A-C are flow charts illustrating embodiments of methods mapping codewords to antennas. The methods are performed in the radio base station.

Looking first to FIG. 13A, the method in the embodiment shown here comprises two steps. The method is used to map one or more codewords to antennas of the same cell under control of a radio base station of a cellular communication system. As described above, the antennas are distributed over at least two different sites and can the antennas can e.g. be used for MIMO. The sites are geographically separated such that there can be a significant difference in average path loss, e.g. a difference of at least 10 dB. Geographically separated can also be defines as a separation of more than 10 metres. As explained above, each site can have two cross-polarised antennas. The codewords can have several purposes, e.g. being associated with DMRS.

In a determine T step 40, a distribution matrix is determined such that each one of the one or more codewords is substantially only mapped to only one site, and more specifically to at least two antennas located at that one site. In other words, each codeword is (substantially) mapped to only one site. In the ideal case, each codeword is only mapped to one site. Substantially is here to be interpreted as at least ninety percent. By mapping each codeword to one site only, the antenna gain imbalance is effectively mitigated or even eliminated.

As explained above, by mapping each codewords to at least two antennas (at one site), multiple layer transmission is still possible and by selection and feedback of the preferred W from the wireless device, some precoding gain is achieved (by co-phasing of the two antenna ports). This would not be possible if the composite precoding matrix TW would map a codeword to a single physical antenna only.

In one embodiment, the composite precoding matrix is determined such that each one of the one or more codewords is mapped to all antennas of only one site. This maximises the number of potential layers that can be used.

In one embodiment, the composite distribution matrix is determined such that each one of the two codewords is mapped to different respective sites. Since link adaptation through modulation and code rate selection is done per codeword, a codeword transmitted from a “weak” site can use a robust modulation and coding whereas a codeword transmitted from a “strong” site can use more aggressive spectral efficiency. This embodiment is useful when the wireless device is located in between the two cross-poles so that both cross-poles could be used but with independent link adaptation for the codewords.

In an apply T step 46, the distribution matrix is applied to the one or more codewords, e.g. as explained above.

FIG. 13B is a flow chart illustrating a method for mapping codewords to antennas according to one embodiment. The method is similar to the method shown in FIG. 13A and only new or modified steps will be described here.

The determine T step optionally comprises determining a distribution matrix which distributes each one of a plurality of CSI-RS signals to all of the at least two different sites. This occurs when the CSI-RS signals are passed through the distribution matrix but not the precoding matrix selected in the select W step below. This scenario is shown in FIG. 8 and explained above.

In an optional select W step 42, one of a set of predefined precoding matrices is selected. The set of predefined precoding matrices is a subset of an entire current codebook. The subset is known above as an effective codebook and has the property that all of the predefined precoding matrices ensures that a codeword is mapped to at least two of the antenna ports at a single site only when combined with the distribution matrix T.

In an optional multiply step 44, the selected precoding matrix is multiplied with the distribution matrix, which results in a composite precoding matrix.

In this embodiment, the applying the distribution matrix comprises applying the composite precoding matrix.

In this embodiment, codewords are still mapped to one site only, but CSI-RS signals are mapped to all sites. This is made possible by passing codewords through both the precoding matrix W and the distribution matrix T (see FIG. 9) while CSI-RS signals are passed through the distribution matrix T but not through the precoding matrix W (See FIG. 8).

FIG. 13C is a flow chart illustrating details of the determine T step 40 of FIGS. 13A-B according to one embodiment. The determine T step 40 here comprises three substeps.

In a select vectors substep 40a, N orthogonal vectors are selected from a codebook \tilde{W}^{(c)} of precoding matrices, where N is the number of antennas. The orthogonal vectors are denoted wₐ_{₁}, wₐ_{₂}, . . . , wₐ_{_{N}}.

In a form T′ substep 40b, a matrix T′=[wₐ_{₁} wₐ_{₂} . . . wₐ_{_{N}}]^{H} is formed, where [ ]^{H} denotes a Hermitian transpose.

In a form T step 40c, forming the distribution matrix is formed as:

$$T = [ \begin{matrix}{T}^{′} & 0 \\ 0 & {T}^{′}\end{matrix} ] .$$

FIG. 14 is a schematic diagram showing functional modules of the radio base station 1 of FIGS. 8-10. The modules can be implemented using software instructions such as a computer program executing in the radio base station 1. The modules correspond to the steps in the methods illustrated in FIGS. 13A-C.

A determiner 70 is arranged to determine a distribution matrix such that each one of the one or more codewords is substantially only mapped to one or more antennas located at only one site. This module corresponds to the determine T step 40 of FIGS. 13A-C.

An applicator 76 is arranged to apply the distribution matrix to the one or more codewords. This module corresponds to the apply T step 46 of FIGS. 13A-C.

A selector 72 is arranged to select one of a set of predefined precoding matrices. This module corresponds to the select W step 42 of FIG. 13B.

A multiplier 74 is arranged to multiply the selected precoding matrix with the distribution matrix, which results in a composite precoding matrix. This module corresponds to the multiply step 44 of FIG. 13B.

FIG. 15 shows one example of a computer program product 90 comprising computer readable means. On this computer readable means a computer program 91 can be stored, which computer program can cause a processor to execute a method according to embodiments described herein. In this example, the computer program product is an optical disc, such as a CD (compact disc) or a DVD (digital versatile disc) or a Blu-Ray disc. As explained above, the computer program product could also be embodied in a memory of a device, such as the computer program product 56 of FIG. 11, or as a removable solid state memory, e.g. a flash storage memory (such as a Universal Serial Bus (USB) drive). While the computer program 91 is here schematically shown as a track on the depicted optical disk, the computer program can be stored in any way which is suitable for the computer program product.

Here now follows a list of embodiments enumerated with roman numerals, from a slightly different perspective.

i. A method for mapping one or more sets of data to antennas of the same cell under control of a radio base station of a cellular communication system, wherein the antennas are distributed over at least two different sites, the method being performed in a radio base station and comprising:
determining (30) a distribution matrix such that each one of the one or more sets of data are mapped to at least two antennas located at only one site; and applying (36) the distribution matrix to the one or more sets of data.
   ii. The method of embodiment i, wherein the determining (30) a composite precoding matrix comprises:
selecting (32) one of a set of predefined precoding matrices; and
multiplying (34) the selected precoding matrix with the distribution matrix (T), which results in a composite precoding matrix;
and wherein the applying the distribution matrix comprises applying the composite precoding matrix.
   iii. The method according to embodiment i or ii, wherein the distribution matrix (T) equals:

$$T = \frac{1}{\sqrt{2}} [ \begin{matrix}1 & 1 & 0 & 0 \\ 1 & - 1 & 0 & 0 \\ 0 & 0 & 1 & 1 \\ 0 & 0 & 1 & - 1\end{matrix} ] .$$

iv. The method according to any one of the preceding embodiments, wherein the sites are geographically separated such that there is a significant difference in average path loss.
v. The method according to any one of the preceding embodiments, wherein the sites are geographically separated such that there is a difference in average path loss of at least 10 dB.
vi. The method according to any one of the preceding embodiments, wherein the sites are geographically separated by more than 10 metres.
vii. The method according to any one of the preceding embodiments, wherein each site comprises two cross-polarised antennas.
viii. The method according to any one of the preceding embodiments, wherein at least part of the one or more sets of data represent Channel State Information Reference Signals.
ix. The method according to any one of the preceding embodiments, wherein at least part of the one or more sets of data represent Demodulation Reference Signals.
x. The method according to any one of the preceding embodiments, wherein the determining (30) a composite precoding matrix comprises determining a composite precoding matrix such that each one of the one or more sets of data are mapped to all antennas of only one site.
xi. The method according to any one of the preceding embodiments, wherein the determining (30) a composite precoding matrix comprises determining a composite distribution matrix such that two sets of data are mapped to different sites.
xii. A radio base station (1) for mapping one or more sets of data to antennas of the same cell under control of the radio base station of a cellular communication system, wherein the antennas are distributed over at least two different sites comprising:
a processor (50); and
a memory (54) storing instructions (56) that, when executed by the processor, causes the radio base station (1) to:
determine a distribution matrix such that each one of the one or more sets of data are mapped to one or more antennas located at only one site; and apply the distribution matrix to the one or more sets of data.
   xiii. The radio base station (1) of embodiment xii, wherein the instructions to determine composite precoding matrix comprises instructions to:
select one of a set of predefined precoding matrices; and
multiply the selected precoding matrix with the distribution matrix (T), which results in a composite precoding matrix;
and wherein the instructions to apply the distribution matrix comprises instructions to apply the composite precoding matrix.
   xiv. The radio base station (1) according to embodiment xii or xiii, wherein the distribution matrix (T) equals:

$$T = \frac{1}{\sqrt{2}} [ \begin{matrix}1 & 1 & 0 & 0 \\ 1 & - 1 & 0 & 0 \\ 0 & 0 & 1 & 1 \\ 0 & 0 & 1 & - 1\end{matrix} ] .$$

xv. The radio base station (1) according to any one of embodiments xii to xiv, wherein the sites are geographically separated such that there is a significant difference in average path loss.
xvi. The radio base station (1) according to any one of embodiments xii to xv, wherein the sites are geographically separated such that there is a difference in average path loss of at least 10 dB.
xvii. The radio base station (1) according to any one of embodiments xii to xiv, wherein the sites are geographically separated by more than a 10 metres.
xviii. The radio base station (1) according to any one of the embodiments xii to xv, wherein each site comprises two cross-polarised antennas.
xix. The radio base station (1) according to any one of embodiments xii to xvi, wherein at least part of the one or more sets of data represent Channel State Information Reference Signals.
xx. The radio base station (1) according to any one of embodiments xii to xvii, wherein at least part of the one or more sets of data represent Demodulation Reference Signals.
xxi. The radio base station (1) according to any one of embodiments xii to xviii, wherein the instructions to determine a composite precoding matrix comprises determining a composite precoding matrix such that each one of the one or more sets of data are mapped to all antennas of only one site.
xxii. The radio base station (1) according to any one of embodiments xii to xix, wherein the instructions to determine a composite precoding matrix comprises instructions to determine a composite distribution matrix such that two sets of data are mapped to different sites.

The invention has mainly been described above with reference to a few embodiments. However, as is readily appreciated by a person skilled in the art, other embodiments than the ones disclosed above are equally possible within the scope of the invention, as defined by the appended patent claims.

1-29. (canceled)

30. A method for mapping one or more codewords to antennas of the same cell under control of a radio base station of a cellular communication system, wherein the antennas are distributed over at least two different sites, the method being performed in a radio base station and comprising:
determining a distribution matrix such that each one of the one or more codewords is substantially only mapped to at least two antennas located at only one site; and
applying the distribution matrix to the one or more codewords.

31. The method of claim 30, wherein in the determining, the distribution matrix is determined such that each one of the one or more codewords is only mapped to at least two antennas located at only one site.

32. The method of claim 30, further comprising:
selecting one of a set of predefined precoding matrices; and
multiplying the selected precoding matrix with the distribution matrix, which results in a composite precoding matrix;
wherein applying the distribution matrix comprises applying the composite precoding matrix.

33. The method of claim 32, wherein determining the distribution matrix comprises determining a distribution matrix that distributes each one of a plurality of Channel State Information Reference Signals to all of the at least two different sites, when the Channel State Information Reference Signals are passed through the distribution matrix but not the selected one of the set of precoding matrices.

34. The method of claim 30, wherein the determining a distribution matrix comprises:
selecting N orthogonal vectors from a codebook \tilde{W}^{(c)} of precoding matrices, where N is the number of antennas, the orthogonal vectors being denoted wₐ_{₁}, wₐ_{₂}, . . . , wₐ_{_{N}};
forming a matrix T′=[wₐ_{₁} wₐ_{₂} . . . wₐ_{_{N}}]^{H} where [ ]^{H} denotes a Hermitian transpose; and
forming the distribution matrix as:
$$T = [ \begin{matrix}{T}^{′} & 0 \\ 0 & {T}^{′}\end{matrix} ] .$$

35. The method of claim 30, wherein the sites are geographically separated such that there is a significant difference in average path loss.

36. The method of claim 30, wherein the sites are geographically separated such that there is a difference in average path loss of at least 10 dB.

37. The method of claim 30, wherein the sites are geographically separated by more than 10 meters.

38. The method of claim 30, wherein each site comprises two cross-polarized antennas.

39. The method of claim 30, wherein at least part of the one or more codewords is associated with Demodulation Reference Signals.

40. The method of claim 30, wherein determining the composite precoding matrix comprises determining the composite precoding matrix such that each one of the one or more codewords is mapped to all antennas of only one site.

41. The method of claim 30, wherein determining the composite precoding matrix comprises determining the composite distribution matrix such that each one of the two codewords is mapped to different respective sites.

42. The method of claim 30, wherein the antennas are used for Multiple-Input Multiple-Output.

43. A radio base station for mapping one or more codewords to antennas of the same cell under control of the radio base station of a cellular communication system, wherein the antennas are distributed over at least two different sites, the radio base station comprising:
a processor; and
a memory storing instructions that, when executed by the processor, cause the radio base station to:
determine a distribution matrix such that each one of the one or more codewords is substantially only mapped to one or more antennas located at only one site; and
apply the distribution matrix to the one or more codewords.

44. The radio base station of claim 43, wherein the instructions to determine comprise instructions that, when executed by the processor, cause the radio base station to determine the distribution matrix such that each one of the one or more codewords is only mapped to at least two antennas located at only one site.

45. The radio base station of claim 43, wherein the memory further comprises instructions that, when executed by the processor, causes the radio base station to:
select one of a set of predefined precoding matrices; and
multiply the selected precoding matrix with the distribution matrix, which results in a composite precoding matrix;
wherein the instructions to apply the distribution matrix comprise instructions to apply the composite precoding matrix.

46. The radio base station of claim 45, wherein the instructions to determine comprise instructions that, when executed by the processor, cause the radio base station to determine a distribution matrix which distributes each one of a plurality of Channel State Information Reference Signals to all of the at least two different sites, when the Channel State Information Reference Signals are passed through the distribution matrix but not the selected one of the set of precoding matrices.

47. The radio base station of claim 43, wherein the instructions to determine a distribution matrix comprise instructions that, when executed by the processor, cause the radio base station to:
select N orthogonal vectors from a codebook \tilde{W}^{(c)} of precoding matrices, where N is the number of antennas, the orthogonal vectors being denoted wₐ_{₁}, wₐ_{₂}, . . . , wₐ_{_{N}};
form a matrix T′=[wₐ_{₁} wₐ_{₂} . . . wₐ_{_{N}}]^{H} where denotes a Hermitian transpose; and
form the distribution matrix as:
$$T = [ \begin{matrix}{T}^{′} & 0 \\ 0 & {T}^{′}\end{matrix} ] .$$

48. The radio base station of claim 43, wherein the sites are geographically separated such that there is a significant difference in average path loss.

49. The radio base station of claim 43, wherein the sites are geographically separated such that there is a difference in average path loss of at least 10 dB.

50. The radio base station of claim 43, wherein the sites are geographically separated by more than 10 meters.

51. The radio base station of claim 43, wherein each site comprises two cross-polarized antennas.

52. The radio base station of claim 43, wherein at least part of the one or more codewords is associated with Demodulation Reference Signals.

53. The radio base station of claim 43, wherein the instructions to determine the composite precoding matrix comprise instructions to determine the composite precoding matrix such that each one of the one or more codewords is mapped to all antennas of only one site.

54. The radio base station of claim 43, wherein the instructions to determine the composite precoding matrix comprise instructions to determine the composite distribution matrix such that each one of the two codewords is mapped to different respective sites.

55. The radio base station of claim 43, wherein the antennas, in operation, are used for Multiple-Input Multiple-Output.

56. A non-transitory computer-readable medium comprising, stored thereupon, a computer program for mapping one or more codewords to antennas of the same cell under control of a radio base station of a cellular communication system, wherein the antennas are distributed over at least two different sites, the computer program comprising computer program code configured so that when the computer program code is run on a radio base station the computer program code causes the radio base station to:
determine a distribution matrix such that each one of the one or more codewords is substantially only mapped to at least two antennas located at only one site; and
apply the distribution matrix to the one or more codewords.
